(19) United States
(12) Patent Application Publication
(10) Pub. No.: US 2026/0352566 A1
(43) Pub. Date: Nov. 5, 2026

(54) METHODS FOR ONLINE LEARNING OF OVER-THE-AIR COMBINER

(71) Applicant: InterDigital Patent Holdings, Inc., Wilmington, DE (US)

(72) Inventors: Asil Koc, Verdun (CA); Philip Pietraski, Jericho, NY (US); Guodong Zhang, Woodbury, NY (US); Mohamed Amine Arfaoui, Montreal (CA); John Kaewell, Jamison, PA (US)

(73) Assignee: InterDigital Patent Holdings, Inc., Wilmington, DE (US)

(21) Appl. No.: 19/198,953

(22) Filed: May 5, 2025

(51) Int. Cl. H04L 41/16; H04L 5/00; H04W 72/044; H04W 72/1268

(52) U.S. Cl. CPC H04L 41/16; H04L 5/0051; H04W 72/044; H04W 72/1268

(57) ABSTRACT

A first device (e.g., WTRU, base station, network node) may receive first configuration information. The first configuration information may indicate that the first device is to participate in online learning of an OTA combiner at a second device (e.g., WTRU, base station, network node). The first device (e.g., WTRU, base station, network node) may receive second configuration information. The second configuration information may be associated with (e.g., uplink) training data that may be associated with the online learning of the OTA combiner. The first device (e.g., WTRU, base station, network node) may send the (e.g., uplink) training data via one or more OTA-reference signals (RSs) based on the second configuration information. The first device (e.g., WTRU, base station, network node) may receive third configuration information. The first device (e.g., WTRU, base station, network node) may send an (e.g., uplink) transmission based on the third configuration information.

### BACKGROUND

AI may be broadly referred to as the behavior exhibited by machines that mimic cognitive functions to sense, reason, adapt, and/or act. An AI component may refer to the realization of behaviors and/or conformance to requirements by learning based on data, without explicit configuration of sequence of procedures of actions. Such AI component(s) may enable learning complex behaviors which might be difficult to specify and/or implement when using other (e.g., legacy) methods.

Machine learning (ML) may refer to the type of algorithm(s) that solve a problem based on learning through experience (e.g., data), without being explicitly programmed (e.g., configuring a set of rules). ML can be considered as a subset of AI. Different ML paradigms may be envisioned based on the nature of data and/or feedback available to the learning algorithm. In examples, a supervised learning approach may include learning a function that maps input to an output based on labeled training example, where each training example may be a pair including an input and its corresponding output. In examples, an unsupervised learning approach may include detecting patterns in the data with no pre-existing labels. In examples, a reinforcement learning approach may include performing sequence of actions in an environment to maximize the cumulative reward. In examples, it may be possible to apply ML algorithms using a combination and/or interpolation of the above-mentioned approaches. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

### SUMMARY

Embodiments described herein may include a receiver with one or more (e.g., multiple) antennas uses an artificial intelligence/machine learning (AI/ML)-based over-the-air (OTA) combiner for improving OTA aggregation accuracy. Online learning of OTA combiner may enable adapting to the dynamic channel condition(s) and/or radio and/or hardware impairment(s). Embodiments described herein may include methods and/or procedures to request, admit, control, and/or terminate the online training of the OTA combiner. Embodiments described herein may include one or more (e.g., multiple) transmitters with one or more (e.g., multiple) antennas using AI/ML for preprocessing and/or re-equalization of transmitted signals to (e.g., further) improve OTA aggregation accuracy.

A wireless transmit/receive unit (WTRU) may be configured to transit an (e.g., uplink) training data during online learning of OTA combiner. The (e.g., uplink) training data may be and/or include pseudo random data (PRD). A network may train the AI/ML-based OTA combiner, for example, by using the received uplink signal, and/or the estimated uplink channel and/or (e.g., uplink) training data through supervised learning. Embodiments described herein may include methods and/or procedures for performance monitoring of AI/ML-based OTA combiner. A WTRU may receive an OTA performance monitoring configuration message. The WTRU may transmit OTA performance monitoring feedback.

A first device (e.g., WTRU, base station, network node) may participate in one or more transmissions synchronized with one or more other devices of values that may correspond to one or more (e.g., common) parameters for combining at a second device. Embodiments described herein may be associated with one or more uses (e.g., OTA-FL, one or more other uses, and/or the like).

A first device (e.g., WTRU, base station, network node) may receive first configuration information. The first configuration information may indicate that the first device is to participate in online learning of an OTA combiner at a second device (e.g., WTRU, base station, network node). The first device (e.g., WTRU, base station, network node) may receive second configuration information. The second configuration information may be associated with (e.g., uplink) training data that may be related to and/or associated with the online learning of the OTA combiner. The first device (e.g., WTRU, base station, network node) may send the (e.g., uplink) training data (e.g., via one or more OTA-reference signals (RSs) based on the second configuration information. The first device (e.g., WTRU, base station, network node) may receive third configuration information. The first device (e.g., WTRU, base station, network node) may send a (e.g., an uplink) transmission based on the third configuration information.

The first configuration information may indicate whether the online learning of the OTA combiner is performed periodically, aperiodically, and/or semi-statistically.

The second configuration information may indicate an allocation of time domain resources, frequency domain resources, and/or code domain resources. The first device (e.g., WTRU, base station, network node) may send the (e.g., uplink) training data (e.g., via the one or more OTA-RSs) using the time domain resources, the frequency domain resources, and/or the code domain resources. The (e.g., uplink) training data may be configured to train the OTA combiner based on, for example, the one or more OTA-RSs and/or one or more AIML models associated with and/or used for an OTA pre-equalizer.

The one or more OTA-RSs may be characterized by a higher density than a physical uplink shared channel (PUSCH) demodulation reference signal (DMRS) and/or a sounding reference signal (SRS).

The second configuration information may indicate that the allocation of time domain resources, frequency domain resources, and/or code domain resources partially overlap and/or fully overlap with the allocation of time domain resources, frequency domain resources, and/or code domain resources allocated for OTA-RS transmissions performed by a third device that is a part of the online learning of the OTA combiner.

The second configuration information may indicate an allocation of time domain resources, frequency domain resources, and/or code domain resources for the one or more OTA-RSs. The allocation of time domain resources, frequency domain resources, and/or code domain resources may result in at least a portion of the OTA-RS transmissions being multiplexed with uplink data.

The third configuration information may include one or more of an indication of an uplink scaling factor, an indication of an uplink pre-equalization technique, an indication of an OTA combining technique at the second device, and/or information associated with whether a plurality of first devices comprise the first device and/or whether the plurality of first devices may be participating in the online learning of the OTA combiner. The (e.g., uplink) transmission may be sent based on one or more of the indication of the uplink scaling factor, the indication of the uplink pre-equalization technique, the indication of the OTA combining technique at the second device, or the information associated with whether the plurality of first devices comprise the first device and whether the plurality of first devices is participating in the online learning of the OTA combiner

The first device (e.g., WTRU, base station, network node) may receive fourth configuration information. The fourth configuration information may include information to train an OTA pre-equalizer (e.g., via supervised learning). The first device (e.g., WTRU, base station, network node) may receive an indication of one or more gradients of end-to-end loss associated with the first device and/or the second device. The OTA pre-equalizer may be trained based on, for example, the one or more gradients of end-to-end loss and/or a differentiation chain rule.

The first device (e.g., WTRU, base station, network node) may receive fourth configuration information. The fourth configuration information may include information to train an OTA pre-equalizer (e.g., via reinforcement learning). The first device (e.g., WTRU, base station, network node) may receive one or more OTA aggregation metrics. The OTA pre-equalizer may be trained based on, for example, the one or more OTA aggregation metrics. For example, the one or more metrics (e.g., OTA aggregation metrics) may be used to train the OTA pre-equalizer.

The first device (e.g., WTRU, base station, network node) may receive fourth configuration information. The fourth configuration information may include information that indicates an OTA pre-equalizer out of a plurality of OTA pre-equalizers. The WTRU may pre-equalize one or more model parameters included in the (e.g., uplink) transmission prior to sending the (e.g., uplink) transmission using the OTA pre-equalizer indicated by the fourth configuration information. The fourth configuration information may include information that indicates an OTA pre-equalizer out of a plurality of OTA pre-equalizers and/or an uplink pre-equalization technique. The (e.g., uplink) transmission may be sent based on the uplink pre-equalization technique and/or the fourth configuration.

The first device (e.g., WTRU, base station, network node) may include an artificial intelligence machine learning (AIML) model. The (e.g., uplink) transmission may include one or more model parameters associated with the AIML model. The AIML model may be configured for one or more inference use cases. The (e.g., uplink) training data may be configured to train the OTA combiner such that the OTA combiner may be configured to reduce OTA aggregation error and/or improve OTA aggregation performance associated with each transmission sent from the first device and/or each transmission sent from a third device.

A plurality of devices may include the first device. The OTA combiner may be configured to combine each respective (e.g., uplink) transmission from each device of the plurality of devices.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of federated learning (FL) over the (e.g., 5G) system.

FIG. 3 depicts an example of (e.g., typical) FL protocol over wireless communication system(s).

FIG. 4 illustrates an example of (e.g., conventional) FL and over-the-air (OTA)-FL in wireless communication system(s).

FIG. 5 illustrates an example of procedures for OTA-FL in wireless communication system(s).

FIG. 6 depicts an example system model with K single-antenna wireless transmit/receive units (WTRUs) and a gNB with N antennas.

FIG. 7 depicts an example of artificial intelligence/machine learning (AI/ML) model architecture for OTA combiner.

FIG. 8 depicts an example of utilization of OTA combiner during training and/or inference.

FIG. 9 depicts an example of AI/ML model architecture for OTA Pre-Equalizer.

FIG. 10 depicts an example flow chart of WTRU procedure(s) for online learning of OTA combiner.

FIG. 11 depicts an example flow chart of combiner node procedure(s) for online learning of OTA combiner.

FIG. 12 depicts an example visualization of Munich scene with ray-traced paths through Sionna RT.

FIGS. 13A and 13B depict examples of WTRU group distributions for generating the dataset.

FIG. 14 depicts an example of test performance for AI/ML-based OTA combiner and maximum ratio combining (MRC).

FIG. 15 depicts an example of training and test performance of OTA combiner for first and second WTRU group distributions.

FIG. 16 depicts an example performance of OTA combiner trained with one or more (e.g., various) WTRU group distributions.

FIG. 17 depicts an example flowchart of WTRU procedure(s) for performance monitoring of OTA combiner.

### DETAILED DESCRIPTION

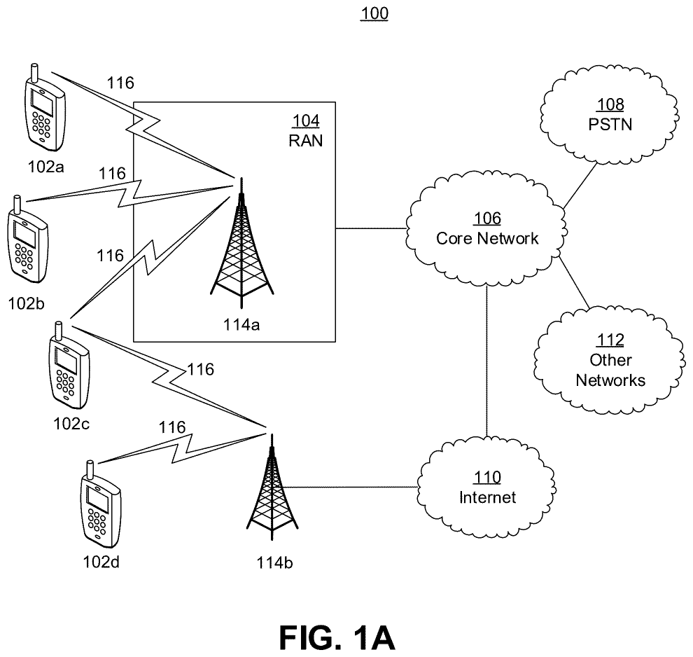

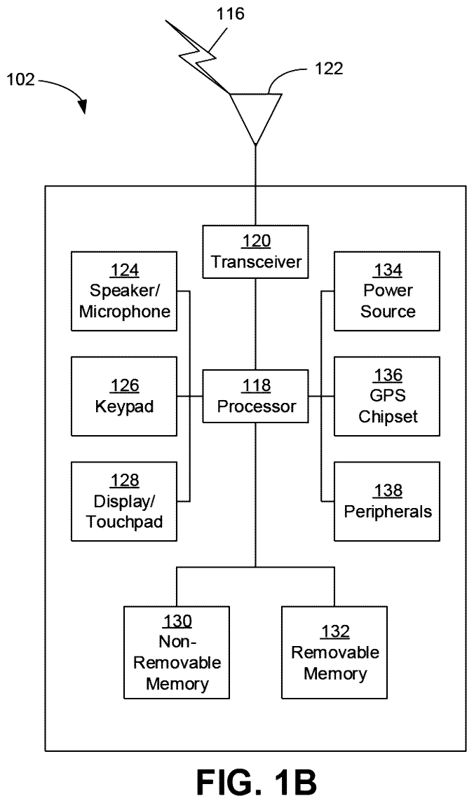

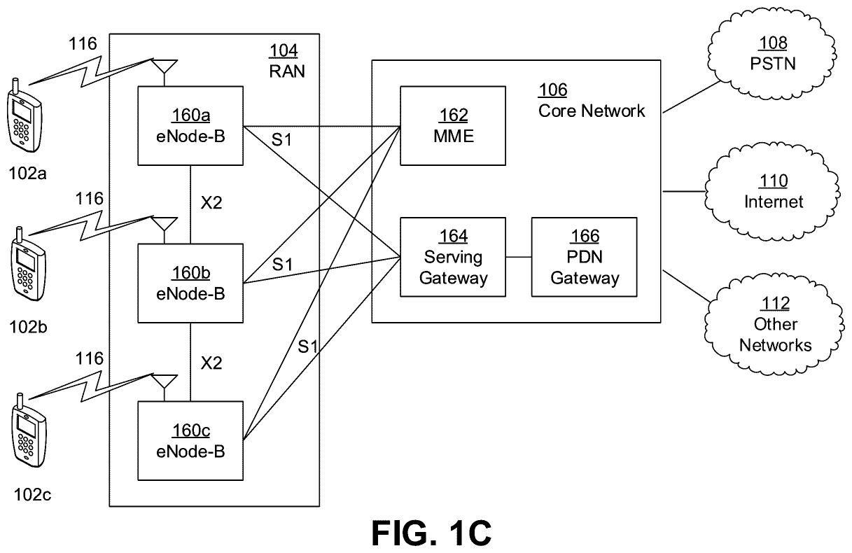

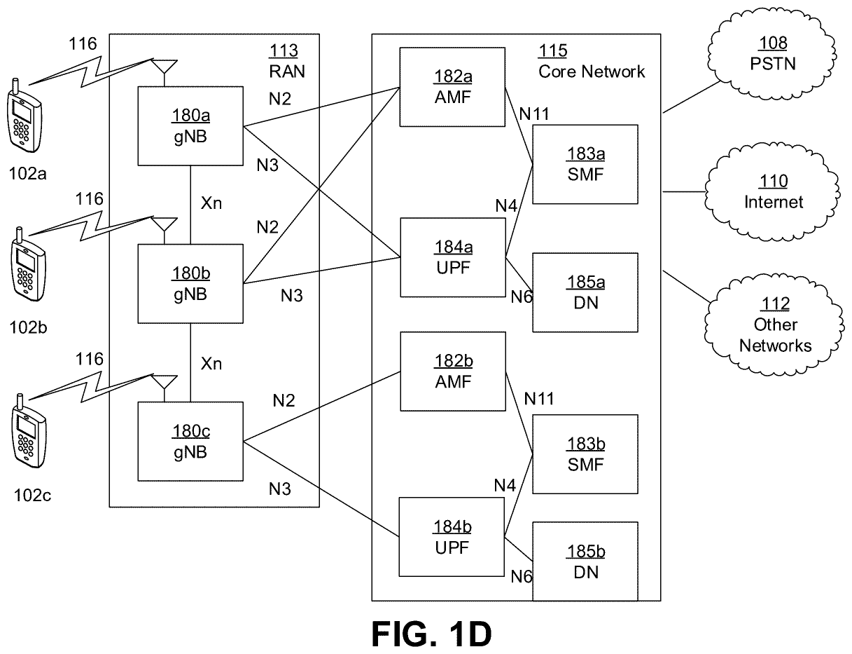

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In over-the-air (OTA) federated learning (FL), one or more (e.g., all) wireless transmit/receive units (WTRUs) participating may (e.g., simultaneously) transmit the (e.g., locally) trained artificial intelligence/machine learning (AI/ML) model parameters over the same time and/or frequency resources for OTA aggregation. When the (e.g., conventional) combining techniques (e.g., maximum ratio combining (MRC) are applied during OTA aggregation, for example, it may lead to additional interference at the receiver. Since each received replica (e.g., received signal at each antenna) may include one or more (e.g., multiple) signals, for example, the additional interference may negatively affect the OTA aggregation quality, which may deteriorate the AI/ML model performance learnt through OTA-FL training round(s). Additionally or alternatively, the amount of interference may increase as more WTRUs participate into the OTA-FL training round(s), which may contradict one of the (e.g., main) goals in FL training.

Embodiments described herein may include a receiver with one or more (e.g., multiple) antennas uses an artificial intelligence/machine learning (AI/ML)-based over-the-air (OTA) combiner for improving OTA aggregation accuracy. Online learning of OTA combiner may enable adapting to the dynamic channel condition(s) and/or radio and/or hardware impairment(s). Embodiments described herein may include methods and/or procedures to request, admit, control, and/or terminate the online training of OTA combiner.

A wireless transmit/receive unit (WTRU) may be configured to transit an (e.g., uplink) training data during online learning of OTA combiner. A network may train the AI/ML-based OTA combiner, for example, by using the received uplink signal, and/or the estimated uplink channel and/or (e.g., uplink) training data through supervised learning. Embodiments described herein may include methods and/or procedures for performance monitoring of AI/ML-based OTA combiner. A WTRU may receive an OTA performance monitoring configuration message. The WTRU may transmit OTA performance monitoring feedback.

For systems combining the over-the-air (OTA) aggregated signals transmitted by multiple transmitters using the same radio resources, for example, embodiments described herein may include methods for online learning of OTA combiner.

AI may be broadly referred to as the behavior exhibited by machines that mimic cognitive functions to sense, reason, adapt, and/or act. An AI component may refer to the realization of behaviors and/or conformance to requirements by learning based on data, without explicit configuration of sequence of procedures of actions. Such AI component(s) may enable learning complex behaviors which might be difficult to specify and/or implement when using other (e.g., legacy) methods.

Machine learning (ML) may refer to the type of algorithm(s) that solve a problem based on learning through experience (e.g., data), without being explicitly programmed (e.g., configuring a set of rules). ML can be considered as a subset of AI. Different ML paradigms may be envisioned based on the nature of data and/or feedback available to the learning algorithm. In examples, a supervised learning approach may include learning a function that maps input to an output based on labeled training example, where each training example may be a pair including an input and its corresponding output. In examples, an unsupervised learning approach may include detecting patterns in the data with no pre-existing labels. In examples, a reinforcement learning approach may include performing sequence of actions in an environment to maximize the cumulative reward. In examples, it may be possible to apply ML algorithms using a combination and/or interpolation of the above-mentioned approaches. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

Deep learning may refer to a class of ML algorithms that employ artificial neural networks, specifically, Deep Neural Networks (DNNs), which were loosely inspired from biological systems. The DNNs may be a special class of ML models that are inspired by the human brain, where the input may be linearly transformed and/or may pass through non-linear activation function one or more (e.g., multiple) times. DNNs may include one or more (e.g., multiple) layers, where each layer may include linear transformation and/or a given non-linear activation function. The DNNs can be trained using the training data via back-propagation algorithm. DNNs may show state-of-the-art performance in one or more (e.g., a variety of) domains (e.g., speech, vision, natural language, wireless communication, etc.), and/or for one or more (e.g., various) ML settings (e.g., supervised, un-supervised, semi-supervised, etc.).

Reinforcement learning (RL) may be a branch of ML that focuses on decision-making by autonomous agent(s). An autonomous agent may represent a system capable of making independent decision(s) and/or responding to its surroundings without (e.g., direct) human intervention. By contrast to supervised and/or unsupervised learning, for example, RL agent(s) may learn to act and/or execute task(s) through trial and error, without (e.g., explicit) human guidance. This app may specifically tackle sequential decision-making challenges within dynamic environment(s).

Reinforcement learning may include the relationship between an agent, an environment, and/or a goal. This relationship may be formulated in terms of the Markov decision process (MDP). The reinforcement learning agent may learn about a problem by interacting with its environment. The environment may provide information on its current state. The agent may use that information to determine which action(s) to take. The decided action may move the environment from its current state to another (e.g., new) state. If that action obtains a positive reward signal from the surrounding environment, for example, the agent may be encouraged to take that action again when in a similar (e.g., future) state. This process may repeat for each (e.g., and/or every, new) state thereafter. Over time, the agent may learn from reward(s) and/or penalty (ies) to take action(s) within the environment that meets a specified goal. In MDP, state space may refer to one or more (e.g. all of) the inform provided by an environment's state and/or action space may refer to one or more (e.g., all) possible actions the agent may take within a state.

The agent may include one or more (e.g., two) components: a policy and/or a learning algorithm. The policy may be a mapping from the current state to a probability distribution of the action(s) to be taken. Within an agent, the policy may be implemented by a function approximator with tunable parameter(s) and/or a specific approximation model, such as neural networks. The learning algorithm may (e.g. continuously) update the policy parameter(s) based on, for example, the action(s), state(s), and/or reward(s). The goal of the learning algorithm may be to find an (e.g., optimal) policy that maximized the expected cumulative long-term reward.

Because an RL agent may have no manually labeled input data guiding its behavior, for example, it may explore its environment, attempting other (e.g., new) action(s) to discover those that may receive reward(s). From these reward signal(s), the agent may learn to prefer action(s) for which it was reward to maximize its gain. The agent may (e.g., continue) exploring other (e.g., new) states and/or action(s) as well. In doing so, it can use that experience to improve its decision-making. RL algorithm(s) may require an agent to (e.g., both) exploit knowledge of previously rewarded state-action(s) and/or explore other state-action(s). The agent may not (e.g., exclusively) pursue exploration and/or exploitation. It may (e.g., continuously) try other (e.g., new) action(s) while (e.g., also) preferring single (and/or chains of) action(s) that may produce the largest cumulative reward.

The applications of AI/ML in wireless communications can improve the performance of communication systems, while wireless communications can be also utilized to improve the AI/ML model performance.

As a distributed machine learning technique, federated learning (FL) may improve the AI/ML model performance towards a stronger model generalization via collaborative learning across decentralized dataset, while preserving the data privacy and/or eliminating the (e.g., large) overhead of dataset sharing. In FL, the central AI server may obtain a global model by combining (e.g., aggregating) local models trained by each participant (e.g. WTRU) based on a model averaging technique. Unlike the (e.g., conventional) centralized learning, FL may preserve the data privacy by removing the need of dataset transfer from the participants (e.g., WTRUs) to the central AI server (e.g., NW) during the AI/ML model training. FL may (e.g., greatly) reduce the communication overhead through eliminating one or more (e.g., large) dataset transfers. The AI/ML models trained through FL may achieve a stronger model generalization compared to the locally trained AI/ML models since, for example, FL enables AI/ML models to learn from datasets from one or more conditions and/or distributions.

A WTRU may perform its local model training within each training cycle based on a model downloaded from the centralized AI server using local data. Once the local model training is completed, for example, the WTRU may deliver the training results (e.g., gradient for the Deep Neural Network-DNN) to the centralized AI server via one or more uplink (UL) channels. The centralized AI server may aggregate the gradients (e.g., model parameters) from the WTRUs, and/or may update the global model. The next training cycle may begin where the AI server distributes the updated global model to WTRUs through one or more downlink (DL) channels.

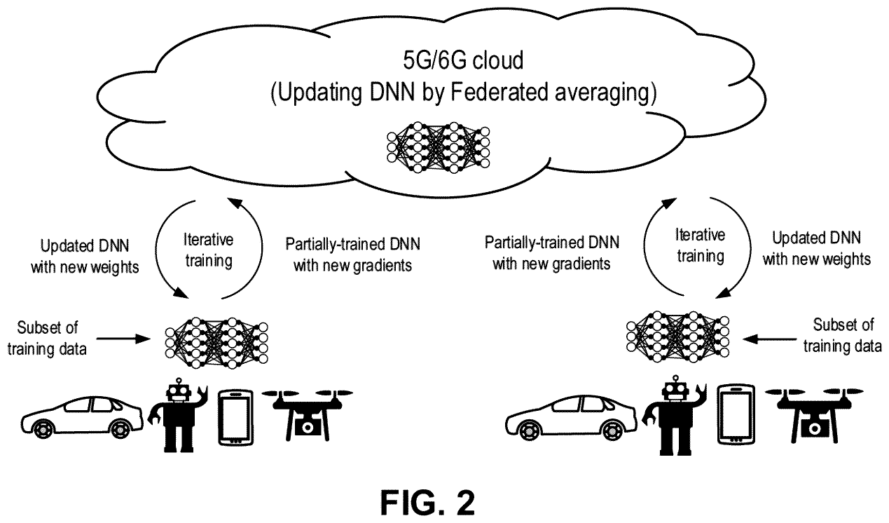

FIG. 2 depicts an example of a high-level interaction between participants (e.g., WTRUs) and the central AI server over a (e.g., 5G) system 200.

The FL training over wireless communication is slightly different than the FL training in data centers, where participants (e.g., WTRUs) may have (e.g., highly) variable conditions in terms of available computational and/or network resources. Additionally or alternatively, the WTRUs may not be homogeneous, so they may have different capabilities in terms of their computing and/or network-related resources, and/or even what ML frameworks they support. It may not be efficient for a centralized AI server to include one or more (e.g., all) of the WTRUs (participants) in a training session, so some sort of member selection mechanism may be required before each training cycle begins. If the conditions (e.g., device's computation resource and/or wireless channel condition) did not change, for example, the WTRU re-selection and/or training re-configurations may not be included for each training cycle. Embodiments described herein may include re-selecting one or more different WTRUs over time to achieve global training with diverse and/or decentralized datasets.

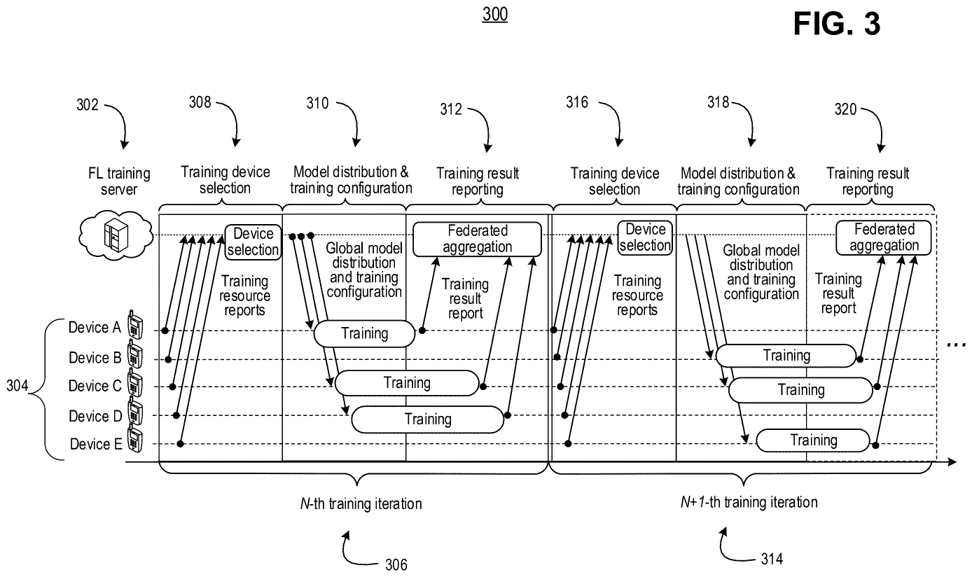

FIG. 3 depicts an example (e.g., typical) FL protocol over wireless communication systems 300. FIG. 3 highlights an example FL scenario where a set of participants (e.g., Devices A-E 304) may be involved in a distributed training session. One or more (e.g., not all) end devices (e.g., WTRUs) may not be involved in each training cycle. In one or more training cycles, one or more WTRUs may be inactive, while in other sessions, they may be busy training a local model. For example, Device A may be initially (e.g., during the Nth cycle 306) engaged in a training session; after it reports its training resources, the centralized FL server 302 may not select Device A for the next cycle (e.g., (N+1)th cycle 314). Instead, the centralized FL server 302 may select Device B, which may be inactive during the Nth cycle 306.

As depicted in FIG. 3, each FL training cycle can be categorized into one or more (e.g., three) operating stages. In a first operating stage (at 308, at 316), the FL server 302 may select a set of training devices (e.g., WTRUs 403). During this stage, the training devices (e.g., 304) may express their training resources to the FL server 302. Once the FL server 304 collects (e.g., all) the information from the one or more training devices, it can select one or more (e.g., some) of them, and/or it may enter a second operating stage (e.g., model distribution and/or training configuration; at 310, at 318), where the FL server 302 may distribute a global trained model and/or related configuration(s) to one or more (e.g., all) selected devices (e.g., WTRUs 304). Upon the other model's arrival and configuration, the WTRUs (e.g., 304) may start local model training (e.g., at a different point in time). Once the local training is completed at a WTRU (e.g., 304), for example, local AI/ML model parameters are delivered to the FL server, where a third operating stage may begin (e.g., at 312, at 320). During this stage, the FL server may aggregate one or more (e.g., all) training results to form a global model and/or may repeat the (e.g., whole) training workflow (e.g., again).

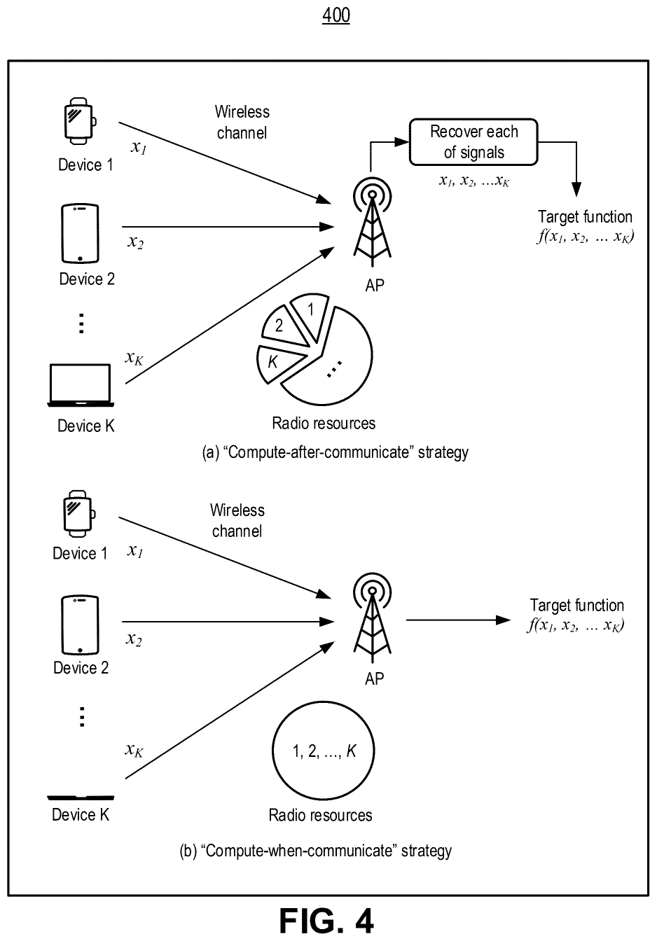

FIG. 4 depicts an example illustration of the (e.g., conventional) FL and/or over-the-air (OTA)-FL in wireless communication systems 400. FL may require a dedicated channel for each participating WTRU, as shown in FIG. 4. End-to-end latency may scale with the number of devices. Over-the-air federated learning (OTA-FL) may enhance the benefit(s) of FL by reducing the end-to-end latency and/or communication overhead through analog aggregation over-the-air. As shown in FIG. 3, each participating WTRU may transmit its locally updated (e.g., trained) AI/ML model parameters (and/or gradients) over interfering radio resources (e.g., channels) during the OTA-FL training rounds. The locally updated AI/ML model parameter(s) may be aggregated and/or combined over-the-air. The NW may receive the aggregated AI/ML model parameters (and/or gradients).

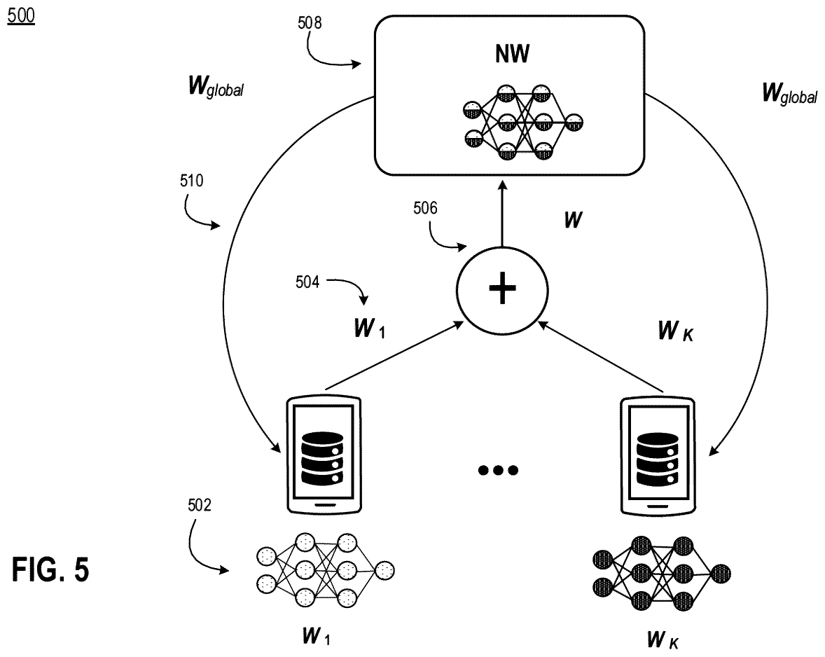

FIG. 5 depicts an example illustration of the procedures for OTA-FL in wireless communication systems 500. FIG. 5 depicts one or more (e.g., five) procedures for OTA-FL in wireless communication systems.

A first procedure (e.g., at 502) for OTA-FL in wireless communication systems may include local training. For example, the WTRU may perform the local AI/ML training through its own dataset.

A second procedure (e.g., at 504) for OTA-FL in wireless communication systems may include pre-processing. The WTRU may perform (e.g., some) pre-processing to the locally updated (e.g., trained) AI/ML model parameter(s) before transmitting them (e.g., computing the gradients, calculating the difference between the locally updated AI/ML model parameter(s) and the received global AI/ML model parameter(s) in the previous OTA-FL training round, etc.).

A third procedure (e.g., at 506) for OTA-FL in wireless communication systems may include OTA aggregation. The WTRU may transmit the locally updated AI/ML model parameter(s) (and/or gradient), where one or more (e.g., all) participating WTRUs may use the same radio resources (e.g., physical channel). The NW may receive the aggregated AI/ML model parameter(s) (and/or gradients). For example, at the example, at the t^{th} OTA-FL training round, the received signal at the NW can be written as follows:

$${y}^{( t )} = {\sum }_{k = 1}^{K} {h}_{k}^{( t )} {w}_{k}^{( t )} + {n}^{( t )} , \qquad ( Equation 1 )$$

where K may be the total number of WTRUs participating in the OTA-FL training rounds,

$${h}_{k}^{( t )}$$

may be the channel between the NW and the k^{th} WTRU (e.g., with single-antenna at the NW and each WTRU) during the t^{th} OTA-FL training round,

$${w}_{k}^{( t )}$$

may be the (e.g., pre-processed) locally updated AI/ML model parameters (and/or gradient) at the k^{th} WTRU, and n^{(t)} may be the receiver noise at the NW in the t^{th} OTA-FL training round. The term y^{(t)} may represent the OTA aggregated AI/ML model parameters (and/or gradient).

A fourth procedure (e.g., at 508) for OTA-FL in wireless communication systems may include post-processing. The NW may apply (e.g., some) post-processing to obtain a (e.g., new) global AI/ML model. In examples, the post-processing may include developing another (e.g., new) global AI/ML model using the received aggregated gradients and/or the global AI/ML model from the previous OTA-FL training round. In example, the post-processing may be performed through a function φ(.) as:

$${\tilde{y}}^{( t )} = φ ( {y}^{( t )} ) \approx {\sum }_{k = 1}^{K} {w}_{k}^{( t )} . \qquad ( Equation 2 )$$

A fifth procedure (e.g., at 510) for OTA-FL in wireless communication systems may include a global model delivery. For example, the network may distribute the updated global AI/ML model to one or more WTRUs.

Where there are one or more (e.g., multiple) antennas at the receiver side (e.g., network for (e.g., uplink) transmission, WTRU for sidelink), the post-processing may (e.g., also) include the utilization of a combiner. The combiner may (e.g., successfully) combine the receiver OTA aggregated AI/ML model parameters at each antenna.

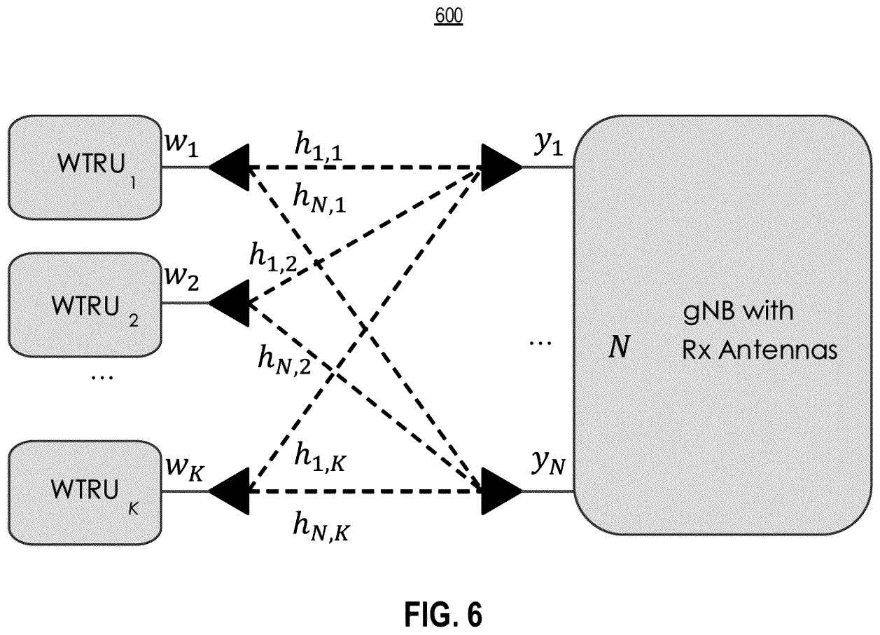

FIG. 6 demonstrates an example scenario, where K single-antenna WTRUs (e.g., simultaneously) transmit their locally trained and/or updated AI/ML model parameters to the gNB with N antennas 600. The received signal at the gNB may be written by:

y=h₁w₁+h₂w₂+ . . . +h_{K}w_{K}+n, (Equation 3)

where w_{K} may be the locally trained/updated AI/ML model parameter at the k^{th} WTRU, hₖ=[h_{1,k}, h_{2,k}) . . . , h_{N,k}]^{T} may represent the channel vector between the k^{th} WTRU and gNB, n=[n₁, n₂, . . . , n_{N}]^{T} may represent the receiver noise. As the post-processing, the combiner may target the (e.g., successful) aggregation/summation of AI/ML model parameters as indicated in Equation 3.

As described herein (e.g., Table 2), the (e.g., conventional) MRC technique can be applied for OTA aggregation. By using Equation 3, for example, the MRC technique can be implemented through choosing the post-processing function as

$$φ ( y ) = {\sum }_{k = 1}^{K} \frac{{h}_{k}^{H} y}{{‖ {h}_{k} ‖}^{2}} .$$

combined signal at the gNB may be expressed as:

$$\tilde{y} = {\sum }_{k = 1}^{K} \frac{{h}_{k}^{H} y}{{‖ {h}_{k} ‖}^{2}} = {\underbrace{{\sum }_{k = 1}^{K} {w}_{k}}}_{Desired Signal} + {\underbrace{{\sum }_{k = 1}^{K} {\sum }_{j \neq k}^{K} \frac{{h}_{k}^{H} {h}_{j}}{{‖ {h}_{k} ‖}^{2}} {w}_{j}}}_{Interference} + {\underbrace{{\sum }_{k = 1}^{K} {\sum }_{j \neq k}^{K} \frac{{h}_{k}^{H} n}{{‖ {h}_{k} ‖}^{2}} .}}_{Noise} \qquad ( Equation 4 )$$

The combined signal \tilde{y} may include the desired signal (e.g., OTA aggregated AI/ML model parameters), interference, and/or noise. The normalized mean square error (NMSE) in OTA aggregation through the conventional MRC technique can be formulated as:

$$NMSE = \frac{{\vert \tilde{y} - {\sum }_{k = 1}^{K} {w}_{k} \vert}^{2}}{{\vert {\sum }_{k = 1}^{K} {w}_{k} \vert}^{2}} = \frac{{\vert {\sum }_{k = 1}^{K} {\sum }_{j \neq k}^{K} \frac{{h}_{k}^{H} {h}_{j}}{{‖ {h}_{k} ‖}^{2}} {w}_{j} + {\sum }_{k = 1}^{K} {\sum }_{j \neq k}^{K} \frac{{h}_{k}^{H} n}{{‖ {h}_{k} ‖}^{2}} \vert}^{2}}{{\vert {\sum }_{k = 1}^{K} {w}_{k} \vert}^{2}} . \qquad ( Equation 5 )$$

FIG. 6 depicts an example of a system model with K single-antenna WTRUs and a gNB with N antennas.

One or more (e.g., conventional) combining techniques in MIMO systems (e.g., MRC) may target improving the received signal quality (e.g., signal to noise ratio (SNR) through using one or more (e.g., multiple) replicas of the same signal. One or more (e.g., all) WTRUs participating in OTA-FL training rounds may (e.g., simultaneously) transmit the locally trained AI/ML model parameters (e.g., gradients, weights, bias) over the same time and/or frequency resources for OTA aggregation(s). When the (e.g., conventional) combining techniques (e.g., MRC) are applied during OTA aggregation, for example, it may lead to additional interference at the receiver since each received replica (e.g., received signal at each antenna) includes one or more (e.g., multiple) signals. The additional interference may negatively affect the OTA aggregation quality, which may deteriorate the AI/ML model performance learnt through OTA-FL training round(s). For example, when the (e.g., conventional) MRC technique is utilized at the receiver (e.g., at the NW for (e.g., uplink) transmission and/or at the WTRU for sidelink), the received signal may include the interference as shown in Equation 4. The amount of interference may increase as more WTRUs participate into the OTA-FL training rounds, which may contradict one of the main goals in FL training (e.g., FL may enjoy more participants for a better model generalization and/or a faster convergence).

Embodiments described herein may include online learning of OTA combiner. In OTA-FL, each participating WTRU may locally train an AI/ML model of the same and/or similar task. When the receiver-side (e.g., network for (e.g., uplink) transmission and/or WTRU for sidelink) has one or more (e.g., multiple) antennas, for example, the receiver can use an AI/ML-based OTA combiner for improving the OTA aggregation accuracy (e.g., reducing the OTA aggregation error. An (e.g., optimal) OTA combiner (e.g., achieving a target OTA aggregation error, achieving the strongest aggregation accuracy, achieving the lowest OTA aggregation error) may be based on one or more (e.g., several) factors such as geometric distribution of WTRUs participating in OTA-FL training round(s), channel type(s) (e.g., indoor, outdoor, etc.), channel quality (e.g., pathloss, SNR), radio and/or hardware impairment(s) (e.g., phase noise, carrier frequency offset, power amplifier non-linearity), and/or the like. One or more factors (e.g., as described herein) may be (e.g., often) difficult to model accurately using analytical and/or deterministic methods. It may be challenging to derive (e.g., optimal) OTA combiner(s) that are applicable to and/or are generalized for one or more (e.g., diverse) scenarios using (e.g., traditional) methods. ML-based approaches may offer an alternative by learning from data and/or adapting to the dynamic channel condition(s) and/or one or more (e.g., various) radio and/or hardware impairments.

Embodiments described herein may include methods and/or procedures to request, admit, control, and/or terminate the online training of OTA combiner. Embodiments described herein may be applicable for one or more (e.g., any) applications aiming to combine the synchronized transmission(s) (e.g., over the same radio resources), where each transmission by a particular transmitter may correspond to a common parameter at the receiver. The common parameter may correspond to data having the same value, such as a common QAM symbol on the same radio resource in an OFDM time-frequency grid, and/or may correspond to analog signal(s) (e.g., real, complex) related by a common statistic (e.g., many temperature measurements where the receive is tasked to compute the mean temperature), and/or may correspond to a common parameter in an AI/ML model architecture shared by the transmitter(s), such as in OTA-FL. The receiver with one or more (e.g., multiple) antennas may target (e.g., successively) combining the one or more (e.g., multiple) received signals at each antenna. The combiner at the receiver may (e.g., also) have one or more (e.g., various) objectives (e.g., summation as in OTA-FL (e.g., see Equation 2 and/or Equation 5), weighted summation, majority vote, geometric mean, polynomial function, etc.). OA-FL may be used as an example application for the one or more embodiments described herein.

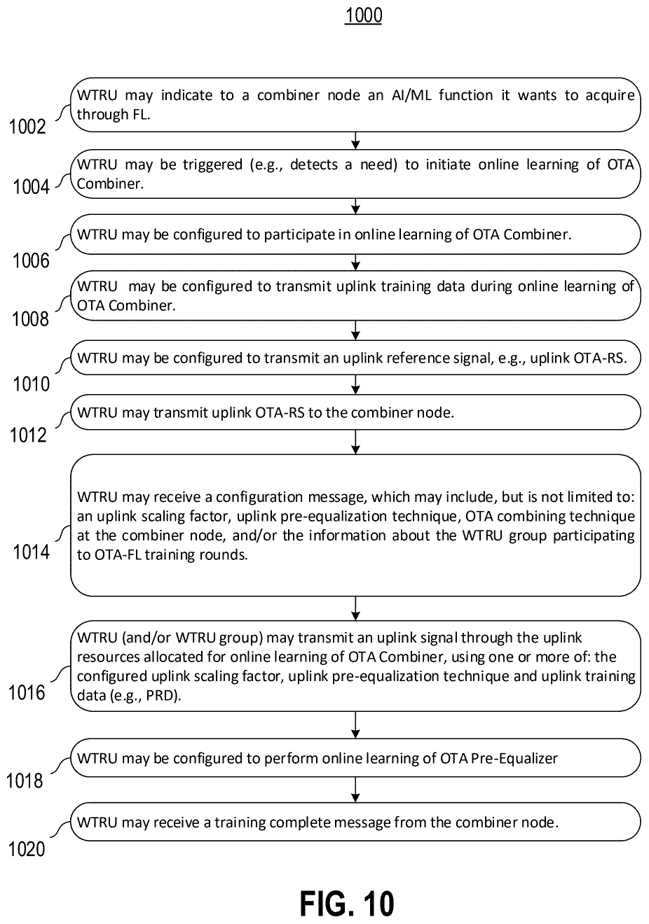

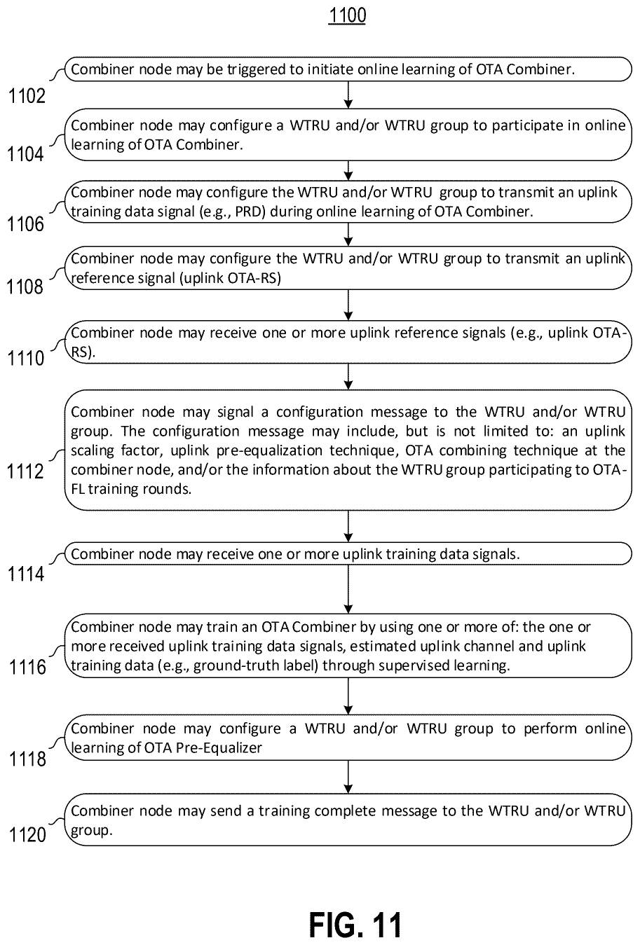

Embodiments described herein include methods and/or procedures for a transmitter node (e.g., WTRU, as depicted in FIG. 10). Embodiments described herein include methods and/or procedures for a combiner node (e.g., as depicted in FIG. 11). The combiner node and/or network can refer to one or more (e.g., any) node in the network (e.g., network, gNB, another WTRU, etc.). For example, the combiner node and/or network can refer to sideline, WTRU-to-WTRU direct communication, and/or the like.

Embodiments described herein include methods and/or procedures for a first device (e.g., transmitter node, WTRU, as depicted in FIG. 10). A first device (e.g., WTRU, base station, network node) may participate in one or more transmissions synchronized with one or more other devices of values that may correspond to one or more (e.g., common) parameters for combining at a second device. Embodiments described herein may be associated with one or more uses (e.g., OTA-FL, one or more other uses, and/or the like).

The first device may be and/or include one or more of the following: a WTRU, a base station, and/or a network node. The second device may be and/or include: a WTRU, a base station, and/or a network device. Embodiments described herein with respect to the first device may, additionally or alternatively, be performed by the second device, and/or vice versa. Embodiments described herein with respect to the second device may, additionally or alternatively, be performed by the first device. For example, the first device, second device, and/or third device may include the OTA combiner and/or the OTA pre-equalizer. The third device (e.g., as described herein) may be and/or include: a WTRU, a base station, and/or a network device. With respect to the group of devices, a group of devices may include one or more combinations of different and/or same device types. For example, a group of devices may include a first WTRU, a second WTRU, and/or a third WTRU. For example, a group of devices may include a WTRU, a base station, and/or a network node.

A first device (e.g., WTRU) may indicate to a combiner node (e.g., the network) an AI/ML function it wants to acquire through FL. The WTRU may indicate if it has a first (e.g., locally trained) AI/ML model. The WTRU may indicate the performance of the first AI/ML model. The WTRU may report the local training data information (e.g., size, quality, diversity, etc.) to the combiner node. The WTRU(s) participating in OTA-FL training round(s) may (e.g., simultaneously) transmit the first AI/ML model parameter(s) (e.g., gradients, weights, bias), over the same time and/or frequency resource elements for OTA aggregation(s). The WTRU and/or WTRU group may receive a second (e.g., global) AI/ML model (and/or a part of a second AI/ML model) from the combiner node. The first (e.g., locally trained) and/or second (e.g., global) AI/ML model may have a common neural network architecture to perform the same and/or similar function(s). The first device (e.g., WTRU, base station, network node) may include an artificial intelligence machine learning (AIML) model. The (e.g., uplink) transmission may include one or more model parameters associated with the AIML model. The AIML model may be configured for one or more inference use cases. The (e.g., uplink) training data may be configured to train the OTA combiner such that the OTA combiner may be configured to reduce OTA aggregation error and/or improve OTA aggregation performance associated with each transmission sent from the first device and/or each transmission sent from a third device.

The first device (e.g., WTRU) may be triggered (e.g., may detect a need) to initiate online learning of OTA combiner. A plurality of devices may include the first device. The OTA combiner may be configured to combine each respective (e.g., uplink) transmission from each device of the plurality of devices.

The first device (e.g., WTRU) and/or a group of first devices (e.g., WTRU group) may be configured (e.g., through radio resource control (RRC) signaling) to participate in online learning of OTA combiner. The training for OTA combiner can be periodic, aperiodic, and/or semi-persistent. The activation and/or deactivation of the configured training may be signaled by a DCI and/or MAC-CE. For example, the WTRU may receive a configuration message. The configuration message may include one or more (e.g., multiple) information fields. For example, the configuration message may include the first configuration information, the second configuration information, and/or the second configuration information. For example, a first device (e.g., WTRU, base station, network node) may receive first configuration information. The first configuration information may indicate that the first device is to participate in online learning of an OTA combiner at a second device (e.g., WTRU, base station, network node). The first configuration information may indicate whether the online learning of the OTA combiner is performed periodically, aperiodically, and/or semi-statistically.

The first device (e.g., WTRU, base station, network node) may receive second configuration information. For example, the WTRU may receive a configuration message. The configuration message may include one or more (e.g., multiple) information fields. For example, the configuration message may include the first configuration information, the second configuration information, and/or the second configuration information. The second configuration information may be associated with (e.g., uplink) training data that may be related to and/or associated with the online learning of the OTA combiner. For example, the WTRU may be configured (e.g., through RRC signaling) to transmit an (e.g., uplink) training data (e.g., pseudo-random data (PRD)) during online learning of OTA combiner. For example, the (e.g., uplink) training data may be and/or include PRD. Examples of (e.g., uplink) training data may include analog PRD (e.g., analog AI/ML model parameter(s), digital PRD (e.g., quantized AI/ML model parameter(s), quadrature amplitude modulation (QAM) symbol(s)), and/or the like. The WTRU may be signaled with the seed of PRD generator by the network. The WTRU may receive uplink resource allocation(s) for transmitting the (e.g., uplink) training data. One or more (e.g., all) WTRUs (e.g., participating in online learning of OTA combiner) may use the same uplink resources (e.g., physical resource blocks (PRBs) and/or resource blocks (RBs)) to transmit the (e.g., uplink) training data (e.g., PRD). The second configuration information may indicate an allocation of time domain resources, frequency domain resources, and/or code domain resources. The first device (e.g., WTRU, base station, network node) may send the (e.g., uplink) training data (e.g., via the one or more OTA-RSs) using the time domain resources, the frequency domain resources, and/or the code domain resources. The (e.g., uplink) training data may be configured to train the OTA combiner based on, for example, the one or more OTA-RSs and/or one or more AIML models associated with and/or used for an OTA pre-equalizer.

The first device (e.g., WTRU) may be configured to transmit an uplink reference signal (RS) (e.g., uplink OTA-RS). The WTRU may receive the uplink OTA-RS allocation(s) as a part of the uplink resource allocation for online learning of the OTA combiner. The first device (e.g., WTRU, base station, network node) may send the (e.g., uplink) training data (e.g., via one or more OTA-reference signals (RSs)) based on the second configuration information. In examples, uplink OTA-RS allocation(s) for each WTRU may be orthogonal in time and/or frequency and/or code domain (e.g., similar to physical uplink shared channel (PUSCH) demodulation reference signal (DMRS) and/or sounding RS (SRS)), while uplink OTA-RS may be with density than PUSCH DMRS and/or SRS. The one or more OTA-RSs may be characterized by a higher density than a physical uplink shared channel (PUSCH) demodulation reference signal (DMRS) and/or a sounding reference signal (SRS). In examples, uplink OTA-RS allocation(s) for each WTRU may be partially and/or fully overlapping in time and/or frequency and/or code domain to reduce RS overhead. The second configuration information may indicate that the allocation of time domain resources, frequency domain resources, and/or code domain resources partially overlap and/or fully overlap with the allocation of time domain resources, frequency domain resources, and/or code domain resources allocated for OTA-RS transmissions performed by a third device that is a part of the online learning of the OTA combiner. In examples, uplink OTA-RS allocation(s) for each WTRU may be multiplexed with uplink data (e.g., PRD during online learning of OTA combiner). Multiplexing OTA-RS and uplink training data may be an example scenario for OTA-RS allocations (e.g., for reducing overhead). Uplink training data may not be tight to the OTA-RS. Uplink training data and OTA-RS may be orthogonal. Uplink training data and OTA-RS may not be orthogonal. Online learning of OTA combiner may be performed with OTA-RS and/or without OTA-RS (e.g., only through SRS). The second configuration information may indicate an allocation of time domain resources, frequency domain resources, and/or code domain resources for the one or more OTA-RSs. The allocation of time domain resources, frequency domain resources, and/or code domain resources may result in at least a portion of the OTA-RS transmissions being multiplexed with uplink data. Uplink OTA-RS resource elements (REs) may be used for uplink channel sounding (e.g., determining the uplink scaling factor) such as SRS. Uplink OTA-RS REs may be used for channel estimation for demodulation (e.g., for combining the received OTA aggregated signals at each receive antenna in OTA-FL training) such as PUSCH DMRS.

The first device (e.g., WTRU) may transmit uplink OTA-RS to the combiner node.

The first device (e.g., WTRU, base station, network node) may receive third configuration information. The third configuration information may include one or more of an indication of an uplink scaling factor, an indication of an uplink pre-equalization technique, an indication of an OTA combining technique at the second device, and/or information associated with whether a plurality of first devices comprise the first device and/or whether the plurality of first devices may be participating in the online learning of the OTA combiner. For example, the WTRU may receive a configuration message. The configuration message may include one or more (e.g., multiple) information fields. For example, the configuration message may include the first configuration information, the second configuration information, and/or the second configuration information. The configuration message may include an uplink scaling factor. The configuration message may include an uplink pre-equalization technique (e.g., no pre-equalization, phase correction, channel inversion, AI/ML-based OTA Pre-Equalizer, etc.). The configuration message may include OTA combining technique at the combiner node (e.g., MRC, AI/ML model #1,AI/ML model #2,etc.). The configuration message may include information about the WTRU group participating to OTA-FL training round(s) (e.g., WTRU group distribution).

There may be one or more (e.g., several) methods of dynamic signaling used to activate and/or deactivate the first, second, and/or third configuration messages (e.g., as described herein). A first method may include a WTRU configured to receive a first dynamic signaling message (e.g., DCI and/or MAC CE) that may activate one or more (e.g., all) three configurations. A second method may include a WTRU configured to receive three separate dynamic signaling messages (e.g., DCI and/or MAC CE) that activate the three configurations one by one. For example, the WTRU may receive a first dynamic signaling message (e.g., DCI and/or MAC CE) that activates the first configuration; the WTRU may receive a second dynamic signaling message (e.g., DCI and/or MAC CE) that activates the second configuration; the WTRU may receive a third dynamic signaling message (e.g., DCI and/or MAC CE) that activates the third configuration; and/or the like. A third method may include the WTRU being configured to receive two separate dynamic signaling messages (e.g., DCI and/or MAC CE) to activate three configurations. For example, the WTRU may receive one dynamic signaling message (e.g., DCI and/or MAC CE) that activates two out of the three configurations (for example, a first dynamic signaling message that activates first and/or second configurations); the WTRU may receive a second dynamic signaling message (e.g., DCI and/or MAC CE) that activates the remaining (e.g., third) configuration(s). For example, a first device (e.g., WTRU) may receive a (e.g., dynamic) signal that indicates activation and/or deactivation of configuration information (e.g., first configuration information, second configuration information, and/or third configuration information).

The first device (e.g., WTRU, base station, network node) may send an (e.g., uplink) transmission based on the third configuration information. The (e.g., uplink) transmission may be sent based on one or more of the indication of the uplink scaling factor, the indication of the uplink pre-equalization technique, the indication of the OTA combining technique at the second device, or the information associated with whether the plurality of first devices comprise the first device and whether the plurality of first devices is participating in the online learning of the OTA combiner. For example, the WTRU and/or WTRU group (e.g., each WTRU included in the WTRU group) may transmit an uplink signal through the uplink resources allocated for online learning of OTA combiner, for example, using one or more of: the configured uplink scaling factor, an uplink pre-equalization technique, and/or (e.g., uplink) training data (e.g., PRD).

The first device (e.g., WTRU, base station, network node) may be configured to perform online learning of OTA pre-equalizer. For example, the WTRU may be configured to perform online learning of OTA pre-equalizer.

The first device (e.g., WTRU, base station, network node) may receive fourth configuration information. The fourth configuration information may include information to train an OTA pre-equalizer (e.g., via supervised learning). The first device (e.g., WTRU, base station, network node) may receive an indication of one or more gradients of end-to-end loss associated with the first device and/or the second device. The OTA pre-equalizer may be trained based on, for example, the one or more gradients of end-to-end loss and/or a differentiation chain rule. For example, the WTRU may be configured to train OTA pre-equalizer through supervised learning. The WTRU may receive the gradient(s) of end-to-end loss (e.g., mean square error of OTA aggregation) with respect to the (e.g., estimated) uplink channel. The WTRU may apply the differentiation chain rule for computing the gradients with respect to the OTA pre-equalizer. The WTRU may train OTA pre-equalizer through supervised learning.

The first device (e.g., WTRU, base station, network node) may receive fourth configuration information. The fourth configuration information may include information to train an OTA pre-equalizer (e.g., via reinforcement learning). The first device (e.g., WTRU, base station, network node) may receive one or more OTA aggregation metrics. The OTA pre-equalizer may be trained based on, for example, the one or more OTA aggregation metrics. For example, the one or more metrics (e.g., OTA aggregation metrics) may be used to train the OTA pre-equalizer. For example, the WTRU may be configured to train OTA pre-equalizer through reinforcement learning. The WTRU may receive one or more OTA aggregation performance metrics (e.g., OTA aggregation error, NMSE, AI/ML model performance, etc.) as a reward. The WTRU may train OTA pre-equalizer through reinforcement learning.

The first device (e.g., WTRU) may perform the online learning of OTA pre-equalizer according to the configuration. The WTRU may report the trained OTA pre-equalizer to the combiner node. The WTRU may store one or more (e.g., multiple) AI/ML models for OTA pre-equalizer (e.g., a library of OTA pre-equalizers). The WTRU may select an OTA pre-equalizer (e.g., from a library of OTA pre-equalizers trained at the WTRU based on the received configuration message (e.g., WTRU group distribution). For example, the first device (e.g., WTRU, base station, network node) may receive fourth configuration information. The fourth configuration information may include information that indicates an OTA pre-equalizer out of a plurality of OTA pre-equalizers. The WTRU may pre-equalize one or more model parameters included in the (e.g., uplink) transmission prior to sending the (e.g., uplink) transmission using the OTA pre-equalizer indicated by the fourth configuration information. The fourth configuration information may include information that indicates an OTA pre-equalizer out of a plurality of OTA pre-equalizers and/or an uplink pre-equalization technique. The (e.g., uplink) transmission may be sent based on the uplink pre-equalization technique and/or the fourth configuration.

The WTRU may receive a training complete message from the combiner node.

Embodiments described herein include methods and/or procedures for a combiner node (e.g., as depicted in FIG. 11, a node that may determine OTA combiner). For example, a combiner node may be and/or include a network and/or a controller WTRU.

The combiner node may be triggered (e.g., detect a need) to initiate online learning of OTA combiner. Triggers to initiate the online learning of OTA combiner may include performance monitoring of AI/ML based OTA combiner and/or the WTRU feedback during OTA-FL training rounds. WTRU feedback may include local performance of the second (e.g., global) AI/ML model received by the combiner node.

The combiner node may configure a WTRU and/or WTRU group (e.g., through RRC signaling) to participate in online learning of OTA combiner. The training for OTA combiner can be periodic, aperiodic, and/or semi-persistent.

The combiner node may configure the WTRU group (e.g., each WTRU in the WTRU group) (e.g., through RRC signaling) to transmit (e.g., an uplink) training data signal (e.g., PRD) during online learning of OTA combiner. Examples of (e.g., uplink) training data may include analog PRD (e.g., unquantized AI/ML model parameter(s), etc.). Examples of (e.g., uplink) training data may include digital PRD (e.g., quantized AI/ML model parameter(s), QAM, etc.). The combiner node may signal with the seed of PRD. The combiner node may re-generate the PRD through the corresponding seed. The combiner node may use the PRD as ground-truth label during online learning of OTA combiner. The combiner node may configure the WTRU group (e.g., each WTRU in the WTRU group) to transmit an uplink reference signal (e.g., uplink OTA-RS). The combiner node may use the received uplink signal for one or more of: uplink channel sounding (e.g., determining the uplink scaling factor) such as SRS; and/or channel estimation for demodulation (e.g., for combining the received OTA aggregated signals at each receive antenna in OTA-FL training) such as PUSCH DMRS.

The combiner node may receive one or more uplink reference signals (e.g., OTA-RS).

The combiner node may signal a configuration message to the WTRU group (e.g., to each WTRU in the WTRU group). The configuration message may include one or more of: an uplink scaling factor, an uplink OTA pre-equalization technique, OTA combining technique at the combiner node, and/or the information about the WTRU group participating in OTA-FL training round(s).

The combiner node may receive one or more (e.g., uplink) training data signals.

The combiner node may train an AI/ML-based OTA combiner, for example, by using one or more of: the one or more received (e.g., uplink) training data signals, the estimated uplink channel for OTA combiner (e.g., through the received uplink OTA-RS and/or DMRS), and/or (e.g., uplink) training data (e.g., ground-truth label) through supervised learning.

The combiner node may configure a WTRU group (e.g., each WTRU in the WTRU group) to perform online learning of OTA pre-equalizer. The combiner node may send one or more of: the gradients of end-to-end loss (e.g., mean square error of OTA aggregation) with respect to the (e.g., estimated) uplink channel; and/or OTA aggregation performance metric(s) (e.g., OTA aggregation error, NMSE, AI/ML model performance, etc.). The combiner node may configure a WTRU group (e.g., each WTRU in the WTRU group) for reporting the trained OTA pre-equalizer. The combiner node may configure a WTRU group (e.g., each WTRU in a WTRU group) to receive a downlink reference signal (e.g., downlink OTA-RS). The downlink OTA-RS may be used as the input to the AI/ML-based OTA pre-equalizer. The downlink OTA-RS may target improving the downlink channel estimation accuracy per RE level.

The combiner node may send a training complete message (e.g., when OTA combiner is sufficiently trained and/or when OTA combiner achieves a target OTA aggregation error).

Embodiments described herein may include performance monitoring of OTA combiner. When AI/ML-based OTA combiner is learned (e.g., based on achieving a target OTA aggregation error), it can be used during inference (e.g., OTA-FL training round(s)). The performance of AI/ML-based OTA combiner may degrade (e.g., over the time) based on one or more (e.g., several) reasons. For example, the distribution of the WTRU group participating in OTA-FL training may vary during the training rounds. Although the trained AI/ML model for OTA combiner can be optimal for the initial WTRU group distribution, for example, another (e.g., the new) WTRU group distribution can make it sub-optimal based the variations in channel condition(s) and/or channel quality. The performance monitoring of OTA combiner may enable: (i) continue using the existing AI/ML model; and/or (ii) fall back to another (e.g., legacy, non-AI/ML) technique (e.g., MRC); and/or re-training and/or fine-tuning the AI/ML based OTA combiner based on experiencing the performance degradation. Embodiments described herein may include procedures for the performance monitoring of AI/ML-based OTA combiner.

Embodiments described herein may be applicable for one or more (e.g., any) applications aiming to combine the synchronized transmission(s) (e.g., over the same radio resources), where each transmission by a particular transmitter may correspond to a common parameter at the receiver. The common parameter may correspond to data having the same value, such as a common QAM symbol on the same radio resource in an OFDM time-frequency grid, and/or may correspond to analog signal(s) (e.g., real, complex) related by a common statistic (e.g., many temperature measurements where the receive is tasked to compute the mean temperature), and/or may correspond to a common parameter in an AI/ML model architecture shared by the transmitter(s), such as in OTA-FL. The receiver with one or more (e.g., multiple) antennas may target (e.g., successively) combining the one or more (e.g., multiple) received signals at each antenna. The combiner at the receiver may (e.g., also) have one or more (e.g., various) objectives (e.g., summation as in OTA-FL (e.g., see Equation 2 and/or Equation 5), weighted summation, majority vote, geometric mean, polynomial function, etc.). OA-FL may be used as an example application for the one or more embodiments described herein.

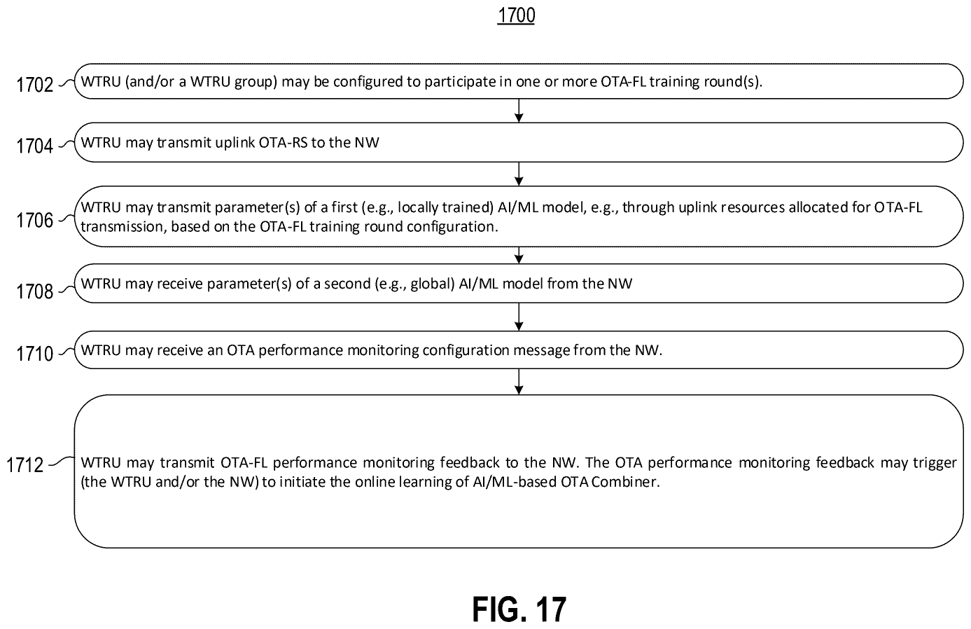

The procedures for monitoring of OTA combiner may be described herein (e.g., as shown in FIG. 17). The network can refer to one or more (e.g., any) node in the network (e.g., combiner node, gNB, another WTRU). For example, the network can refer to (e.g., WTRU) sidelink, WTRU-to-WTRU direct communication, and/or the like.

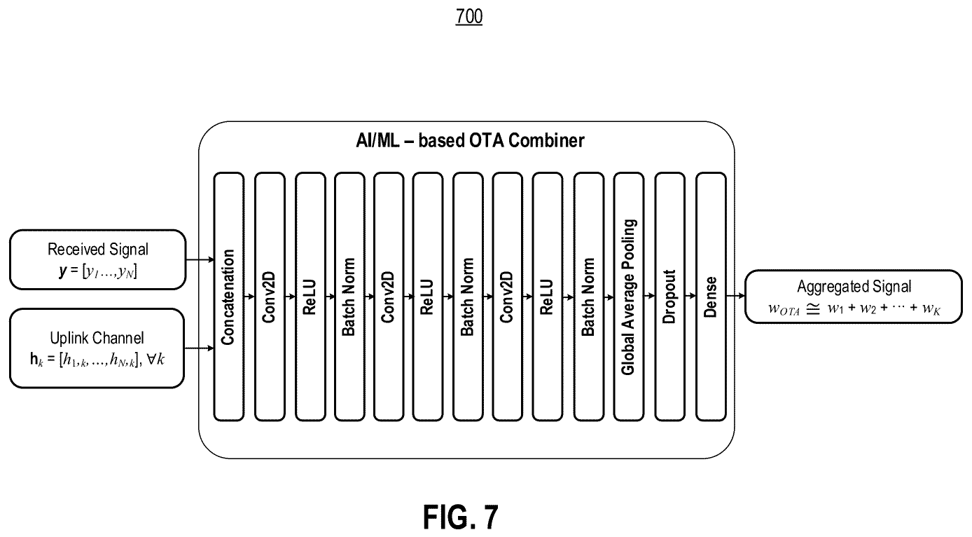

A WTRU and/or WTRU group (e.g., each WTRU in the WTRU group) may be configured to participate in one or more OTA-FL training round(s). The WTRU may receive an indication to identify which part(s) of the AI/ML model may be trained and/or updated through OTA-FL training round(s) (e.g., only last few layers may be trained). The WTRU may receive uplink resource allocation(s) for OTA-FL training round(s), which may be common for one or more (e.g., all) WTRUs participating in the same one or more OTA-FL training round(s). This may mean that one or more (e.g., all) WTRUs use the same uplink resources to transmit the first (e.g., locally trained) AI/ML model parameter(s). The WTRU may receive the uplink OTA-RS allocation(s) as a part of the uplink resource allocation for OTA-FL training round(s). The WTRU may receive a configuration about how the first (e.g., locally trained) AI/ML model parameter(s) are mapped to uplink resources (e.g., as shown in FIG. 7). The WTRU may be configured with the uplink pre-equalization technique (e.g., no pre-equalization, phase correction, channel inversion, AI/ML-based OTA pre-equalizer, etc.). The WTRU may receive training related information (e.g., loss function, learning rate, a set of thresholds to monitor the training progress, etc.). The WTRU may be configured to transmit a (e.g., new) uplink reference signal (e.g., uplink OTA-RS). The WTRU may receive the uplink OTA-RS allocation(s) as a part of the uplink resource allocation.

The WTRU may transmit uplink OTA-RS to the network.

The WTRU (and/or WTRU group) (e.g., each WTRU in the WTRU group) may transmit parameter(s) of a first (e.g., locally trained) AI/ML model (e.g., through the uplink resources allocated for OTA-FL transmission (e.g., OTA aggregation), based on, for example, the OTA-FL training round configuration.

The WTRU (and/or WTRU group) (e.g., each WTRU in the WTRU group) may receive parameter(s) of a second (e.g., global) AI/ML model (and/or a part of a second AI/ML model) from the network. The first (e.g., locally trained) and/or second (e.g., global) AI/ML models may have a common neural network architecture to perform the same and/or similar function(s).

The WTRU may receive an OTA performance monitoring configuration message from the network. The WTRU may use an OTA performance monitoring configuration message to test and/or monitor the performance of the received second (e.g., global) AI/ML model. The OTA performance monitoring configuration message may include one or more of: one or more performance thresholds (e.g., 50% accuracy in a classification use case); one or more performance update thresholds (e.g., the performance difference between the first and second AI/ML models); and/or one or more model update thresholds (e.g., the delta between a set of the first (e.g., locally trained) and second (e.g., global) AI/ML model parameter(s)). For example, the OTA performance monitoring configuration message may include one or more model update thresholds for each model parameter, and/or one or more model update thresholds for a set of model parameters, and/or one or more model update thresholds for one or more (e.g., all) model parameters.

The WTRU may transmit OTA performance monitoring feedback (e.g., determined using the OTA performance monitoring configuration). The OTA performance monitoring feedback may trigger (e.g., the WTRU and/or the network) to initiate the online learning of AI/ML-based OTA combiner. The OTA performance monitoring feedback may trigger (e.g., the WTRU and/or the network) to initiate the online learning of AI/ML-based OTA pre-equalizer. One or more of the following exemplary events may trigger the WTRU to send the OTA performance monitoring feedback. In examples, the performance monitoring threshold may be set to 50% accuracy in a classification use case. If the received second (e.g., global) AI/ML model achieves (e.g., only) 20% accuracy, for example, the WTRU may transmit OTA performance monitoring feedback. In examples, the performance update threshold may be set to −10% accuracy in a classification use case. If the received second (e.g., global) AI/ML model achieves (e.g., only) 40% accuracy, while the first (e.g., locally trained) AI/ML model achieves 60% accuracy, for example, the delta may be −20% accuracy. Since the delta is lower than the configured performance update threshold, for example, the WTRU may transmit OTA performance monitoring feedback. In examples, the model update threshold may be set to δ. w_{1,i} may refer to the model parameter(s) of the first (e.g., locally trained) AI/ML model. w_{2,i} may refer to the model parameter(s) of the second (e.g., global) AI/ML model. i∈{1, 2, . . . , P} may represent the index of model parameter(s). When

$$δ > {max}_{i} \vert {w}_{1 , i} - {w}_{2 , i} \vert and / or δ > {\sum }_{i = 1}^{P} \vert {w}_{1 , i} - {w}_{2 , i} \vert and / or δ > \frac{1}{P} {\sum }_{i = 1}^{P} \vert {w}_{1 , i} - {w}_{2 , i} \vert ,$$

for example, the WTRU may transmit OTA performance monitoring feedback. One or more other measures of distance may (e.g., also) be used (e.g., in comparison to a threshold).

In OTA-FL, each participating WTRU may (e.g., locally) train an AI/ML model for the same (and/or similar) task. When the receiver-side (e.g., network for (e.g., uplink) transmission and/or WTRU for sidelink) has one or more (e.g., multiple) antennas, for example, the receiver can use an AI/ML-based OTA FL combiner for improving the OTA aggregation accuracy (e.g., reducing the OTA aggregation error). An optimal OTA combiner may be based on one or more (e.g., several) factors such as geometric distribution of WTRUs participating in OTA-FL training round(s), channel type(s) (e.g., indoor, outdoor, etc.), channel quality (e.g., pathloss, SNR), radio and/or hardware impairment(s) (e.g., phase noise, carrier frequency offset, power amplifier non-linearity), and/or the like. One or more factors (e.g., as described herein) may be (e.g., often) difficult to model accurately using analytical and/or deterministic methods. It may be challenging to derive (e.g., optimal) OTA combiner(s) that are applicable to and/or are generalized for one or more (e.g., diverse) scenarios using (e.g., traditional) methods. ML-based approaches may offer an alternative by learning from data and/or adapting to the dynamic channel condition(s) and/or one or more (e.g., various) radio and/or hardware impairments. Embodiments described herein may include methods and/or procedures to request, admit, control, and/or terminate the online training of OTA combiner.

Embodiments described herein may be applicable for one or more (e.g., any) applications aiming to combine the synchronized transmission(s) (e.g., over the same radio resources), where each transmission by a particular transmitter may correspond to a common parameter at the receiver. The common parameter may correspond to data having the same value, such as a common QAM symbol on the same radio resource in an OFDM time-frequency grid, and/or may correspond to analog signal(s) (e.g., real, complex) related by a common statistic (e.g., many temperature measurements where the receive is tasked to compute the mean temperature), and/or may correspond to a common parameter in an AI/ML model architecture shared by the transmitter(s), such as in OTA-FL. The receiver with one or more (e.g., multiple) antennas may target (e.g., successively) combining the one or more (e.g., multiple) received signals at each antenna. The combiner at the receiver may (e.g., also) have one or more (e.g., various) objectives (e.g., summation as in OTA-FL (e.g., see Equation 2 and/or Equation 5), weighted summation, majority vote, geometric mean, polynomial function, etc.). OA-FL may be used as an example application for the one or more embodiments described herein.

Embodiments may include AI/ML for OTA combiner. The combiner node (e.g., the network) may use an AI/ML model for the OTA combiner. The combiner node and/or the network can refer to one or more (e.g., any) nodes in the network (e.g., combiner node, gNB, another WTRU (e.g., sidelink, WTRU-to-WTRU direct communication), and/or the like. The stages of the AI/ML process may be described herein.

An application may be and/or include OTA combiner.

Input data of AI/ML model may include one or more of: estimated uplink channel, received data REs, received uplink OTA-RS REs and/or uplink OTA-RS pilots, received DMRS REs and/or DMRS pilots, received SRS REs and/or SRS pilots, reference signal received power (RSRP), and/or noise power estimate.

Preprocessing associated with the AI/ML model may include one or more of the following. Preprocessing may include extraction of the received data REs from the received signal(s) using the configured data locations (e.g., allocations). Preprocessing may include extraction of the receive uplink OTA-RS REs (and/or DMRS REs) from the received signal(s) using the configured uplink OTA-RS location(s) (e.g., allocations). Extraction of the receive uplink OTA-RS REs (and/or DMRS REs) from the received signal(s) may include division of the received uplink OTA-RS REs by known uplink OTA-RS pilots. Extraction of the receive uplink OTA-RS REs (and/or DMRS REs) from the received signal(s) may include multiplication of the received uplink OTA-RS REs by conjugate of the known uplink OTA-RS pilots. Extraction of the receive uplink OTA-RS REs (and/or DMRS REs) from the received signal(s) may include estimating the uplink channel for each data RE (e.g., applying an interpolation and/or a 2D filtering to the preprocessed uplink OTA-RS REs). Preprocessing may include reshaping the input data shape. Preprocessing may include calculating the combined signal through one or more (e.g., the legacy) combiner techniques (e.g., MRC) by using the extracted data REs and/or the estimated uplink channel. Preprocessing may include concatenation of the real and imaginary part(s) to obtain a real-valued AI/ML model input.

FIG. 7 illustrates an example AI/ML model architecture for the OTA-combiner 700. The model may be constructed using a combination of concatenation layer(s), convolution layer(s), batch normalization layer(s), ReLU activation layer(s), global average pooling layer(s), dropout layer(s), and/or dense (e.g., fully connected) layer(s). The example AI/ML model in FIG. 7 may take the received signal y and/or the uplink channel vector for each WTRU as hₖ for k=1, 2, . . . , K as the input (e.g., Equation 3). Additionally or alternatively, the AI/ML model may predict the OTA aggregated signal W_{OTA}, which may target approaching the aggregation and/or summation of the AI/ML model parameter(s) sent by each WTRU (e.g., w₁+w₂+ . . . +w_{K}). An example AI/ML model in FIG. 7 can be expressed as:

W_{OTA}=f_{AIML} (y,h₁,h₂, . . . ,h_{K})≈w₁+w₂+ . . . +w_{K}, (Equation 6)

where f_{AIML} (.) may represent the AI/ML-based OTA Combiner.

AI/ML model output may include one or more of the following. AI/ML model output may include aggregated AI/ML model parameter(s) (e.g., w₁+w₂+ . . . +w_{K}). AI/ML model output may include averaged AI/ML model parameter(s)

$$( e . g . , \frac{1}{K} ( {w}_{1} + {w}_{2} + … + {w}_{K} ) ) .$$

An AI/ML model may be trained. The WTRU may be configured to transmit (e.g., uplink) training data (e.g., PRD) during the online learning of OTA combiner. One or more (e.g., all) WTRUs (e.g., participating in online learning of OTA combiner) may use the same uplink resources (e.g., PRBs and/or RBs) to transmit the (e.g., uplink) training data.

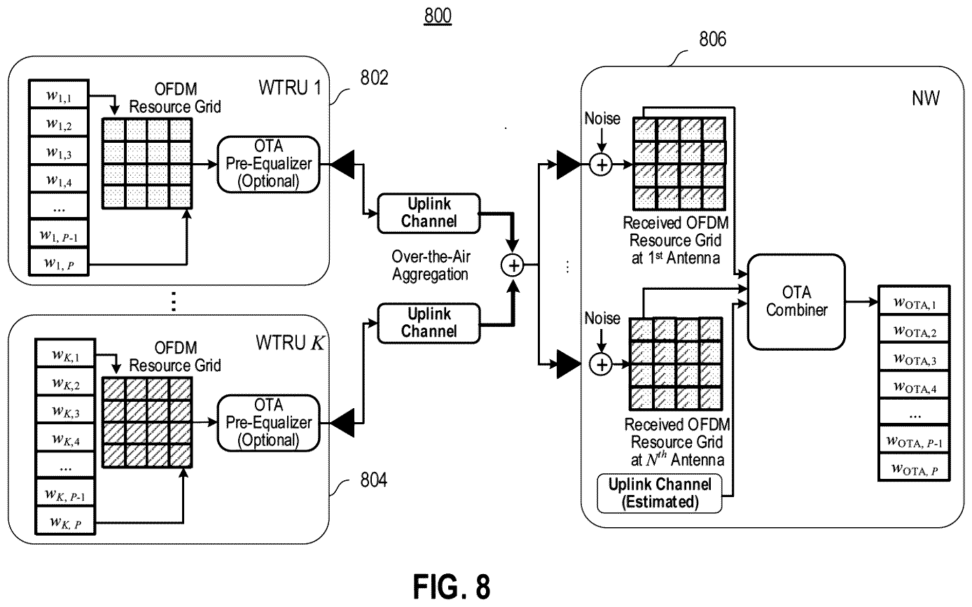

FIG. 8 depicts an example utilization of OTA combiner during online learning 800. w_{k,i} may denote the i^{th} (e.g., uplink) training data symbol transmitted by the k^{th} WTRU with i=1, . . . , P. For example, the OFDM resource grid at the first antenna at the second device (e.g., network 806) may depict an example (e.g., first) OTA aggregation of the signaling sent from the first device (e.g., WTRU 1 802) and a third device (e.g., WTRU K 804). For example, the OFDM resource grid at the Nth antenna at the second device (e.g., network 806) may depict an example (e.g., second) OTA aggregation of the signaling sent from the first device (e.g., WTRU 1 802) and a third device (e.g., WTRU K 804). Additionally or alternatively (e.g., in addition to WTRU 1 802 and/or WTRU K 804), there may be one or more other devices (e.g., k=1,2,3, . . . k). The WTRU may (e.g., also) use OTA Pre-Equalizer while transmitting the (e.g., uplink) training data. The combiner node may train the OTA Combiner, for example, by using the received uplink signal, the estimated uplink channel, and/or (e.g., uplink) training data (e.g., ground-truth label) through supervised learning. For example, the WTRU may be configured to transmit PRD as the (e.g., uplink) training bits. The combiner node may signal with the seed of PRD and/or may re-generate the PRD through the corresponding seed. As shown in Equation 6 OTA combiner may predict W_{OTA} and/or ground truth label may (e.g., also) be known at the combiner node. By using mean square error, for example, the AI/ML model loss may be defined as:

LOSS=|w_{OTA}−(w₁+w₂+ . . . +w_{K})|². (Equation 7)

FIG. 8 depicts an example utilization of OTA combiner during inference 800. w_{k,i} may denote the first (e.g., locally trained) AI/ML model parameter(s). The combiner node may use the trained AI/ML model for OTA Combiner during the OTA-FL training round(s).

The WTRU may use an AI/ML model for the OTA pre-equalizer. The stages of the AI/ML process may include one or more of the following. The application may be and/or include OTA pre-equalizer.

Input data of the AI/ML model may include one or more of: the first (e.g., locally trained) AI/ML model parameter(s); the (e.g., uplink) training data (e.g., PRD); received downlink OTA-RS REs and/or downlink OTA-RS pilot(s); estimated downlink channel; received channel state information (CSI)-RS REs; CSI-RS pilots; and/or RSRP.

Preprocessing may include one or more of the following: estimating the downlink channel through the received CSI-RS REs; extraction of the received downlink OTA-RS REs from the received signals using the configured downlink OTA-RS location(s) (e.g., allocations); concatenation of the real and imaginary part(s) of the estimated downlink channel to obtain a real-valued AI/ML model input; and/or reshaping the input data shape. Extraction of the received downlink OTA-RS REs from the received signals using the configured downlink OTA-RS location(s) (e.g., allocations) may include one or more of: division of the received downlink OTA-RS REs by known downlink OTA-RS pilots; multiplication of the received downlink OTA-RS REs by conjugate of the known downlink OTA-RS pilots; and/or estimating the downlink channel for each data RE(s) (e.g., applying an interpolation and/or a 2D filtering to the preprocessed downlink OTA-RS RE).

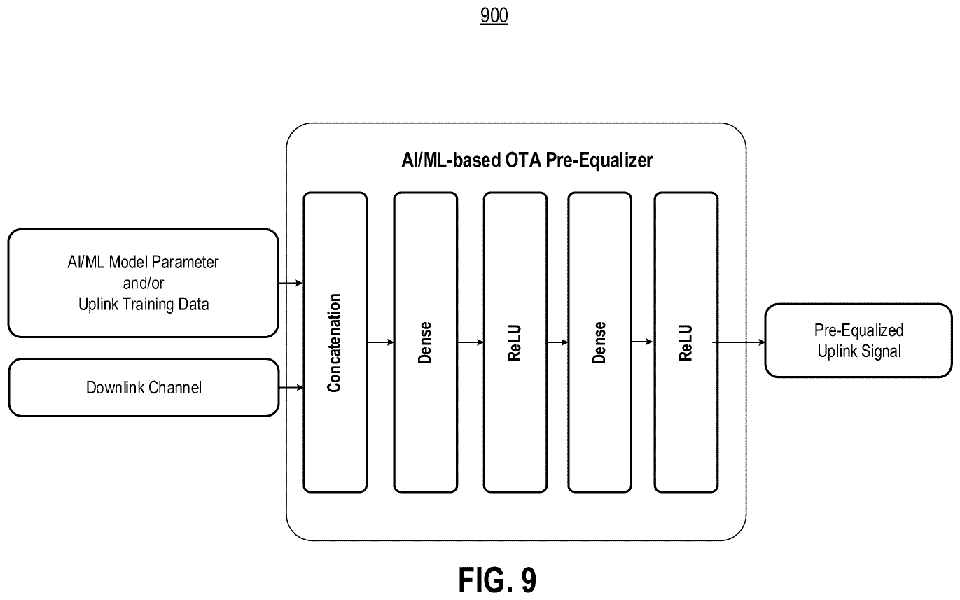

FIG. 9 depicts an example AI/ML model architecture for the OTA Pre-equalizer 900. The model may be constructed using a combination of one or more concatenation layers, dense (e.g., fully connected) layer(s), and/or ReLU activation layer(s). The example AI/ML model in FIG. 9 may take the AI/ML model parameter(s) (and/or (e.g., uplink) training data during online learning) and/or the downlink channel estimate as the input(s). The AI/ML model may output the pre-equalized uplink signal.

Output data of the AI/ML model may include one or more of: pre-equalized (e.g., uplink) training data during online learning; and/or pre-equalized AI/ML model parameter(s) during the inference.

The AI/ML model may be trained. The WTRU may be configured to transmit uplink data (e.g., PRD) during the online learning of the OTA pre-equalizer. One or more (e.g., all) WTRUs may use the same uplink resources (e.g., PRBs and/or RBs) to transmit the (e.g., pre-equalized (e.g., uplink) training data. FIG. 8 depicts an example utilization of OTA pre-equalizer during online learning. As described herein, the training can be performed through supervised learning and/or reinforcement learning.

Training may be performed through supervised learning. The transmission and/or reception blocks involved in the end-to-end transmission (e.g., at the WTRU and the combiner node respectively) may be determined to be differentiable and/or can be approximated as such. By using the differentiation chain rule and/or determining on or more (e.g., all) transmission and/or reception blocks are differentiable (and/or can be approximated), for example, the WTRU and/or the combiner node may compute the gradients of end-to-end loss with respect to the trainable AI/ML model parameter(s) in the OTA pre-equalizer. The combiner node may compute end-to-end loss (e.g., mean square error of OTA aggregation) by using the received uplink signal and/or (e.g., uplink) training data (e.g., PRD). The combiner node may compute the gradient(s) of end-to-end loss with respect to the (e.g., estimated) uplink channel and/or may send it to the WTRU. The WTRU may apply the differentiation chain rule for computing the gradient(s) of end-to-end loss with respect to the trainable AI/ML model parameter(s) in the OTA pre-equalizer. The WTRU may train the OTA pre-equalizer through supervised learning.

Training may be performed through reinforcement learning. The combiner node may compute one or more OTA aggregation performance metrics (e.g., OTA aggregation error, NMSE, AI/ML model performance) and/or may send it to the WTRU. The WTRU may receive one or more OTA aggregation performance metrics as a reward. The WTRU may train OTA pre-equalizer through reinforcement learning. The reinforcement learning agent at the WTRU may take action to update the OTA pre-equalizer based on, for example, the received reward(s). The decided action by the agent may move the environment from its current state to another (e.g., new) state.

FIG. 8 depicts an example utilization of OTA pre-equalizer during inference, where w_{k,i} may denote the first (e.g., locally trained) AI/ML model parameter(s). The WTRU may use the trained AI/ML model for OTA pre-equalizer to generate the pre-equalized AI/ML model parameter(s) during OTA-FL training round(s).

The network (and/or combiner node) may initiate the WTRU capability exchange process, for example, by sending the UECapabilityEnquiry RRC message to the WTRU. The UECapabilityEnquiry RRC message may be used to request (e.g., specific) information regarding the capability (ies) of the WTRU. The network may include parameter(s) in the UECapabilityEnquiry RRC message to specify which capability (ies) the network is interested in. The network may specify one or more parameters related to WTRU capability to support online learning of OTA combiner (and/or OTA pre-equalizer) in the UECapabilityEnquiry message (e.g., the capability of transmitting (e.g., uplink) training data for online learning of OTA combiner, performing uplink pre-equalization through AI/ML based OTA pre-equalizer, transmitting AI/ML model parameter(s), etc.).

Upon receiving the UECapabilityEnquiry RRC message, for example, the WTRU may respond with UECapabilityInformation RRC message (e.g., accordingly). The UECapabilityInformation RRC message may include (e.g., detailed) information about the capability (ies) of the WTRU in supporting online learning of OTA combiner (and/or OTA pre-equalizer). During the WTRU capability exchange process between the WTRU and the network, one or more of the following parameters may be included. During the WTRU capability exchange process between the WTRU and the network, an indicator of whether supporting OTA-FL is supported or not may be included. During the WTRU capability exchange process between the WTRU and the network, an indicator of whether transmitting AI/ML capability (ies) is supported or not may be included. During the WTRU capability exchange process between the WTRU and the network, an indicator of whether the first (e.g., locally trained) AI/ML model may be present at the WTRU or not may be included. During the WTRU capability exchange process between the WTRU and the network, an indicator of whether reporting the local training data information (e.g., size, quality, diversity) is supported or not may be included. During the WTRU capability exchange process between the WTRU and the network, an indicator of whether transmitting the first (e.g., locally trained) AI/ML model parameter(s) (e.g., gradients, weights, bias) is supported or not may be included. During the WTRU capability exchange process between the WTRU and the network, an indicator of whether receiving the second (e.g., global) AI/ML model is supported or not may be included. During the WTRU capability exchange process between the WTRU and the network, an indicator of whether training and/or fine-tuning of the received second (e.g., global) AI/ML model is supported or not may be included. During the WTRU capability exchange process between the WTRU and the network, an indicator of whether training and/or fine-tuning of a part of the received second (e.g., global) AI/ML model (e.g., only the last few layers) is supported or not may be included. During the WTRU capability exchange process between the WTRU and the network, an indicator of whether participating in online learning of OTA combiner is supported or not may be included. During the WTRU capability exchange process between the WTRU and the network, an indicator of whether transmitting OTA-RS is supported or not may be included. During the WTRU capability exchange process between the WTRU and the network, an indicator of whether receiving downlink OTA-RS is supported or not may be included. During the WTRU capability exchange process between the WTRU and the network, an indicator of whether generating the PRD (e.g., as uplink training data) through the configured seed is supported or not may be included. During the WTRU capability exchange process between the WTRU and the network, an indicator of whether transmitting the (e.g., uplink) training data for online learning of OTA combiner is supported or not may be included. During the WTRU capability exchange process between the WTRU and the network, an indicator of whether performing the uplink pre-equalization (e.g., AI/ML-based OTA pre-equalizer, phase correction, channel inversion, etc.) is supported or not may be included. During the WTRU capability exchange process between the WTRU and the network, an indicator of whether transmitting an uplink signal through the uplink resources allocated for online learning of OTA combiner-using one or more of: the configured uplink scaling factor, uplink pre-equalization technique, and/or (e.g., uplink) training data—is supported or not may be included. During the WTRU capability exchange process between the WTRU and the network, an indicator of whether performing online learning of OTA pre-equalizer (e.g., through supervised learning and/or reinforcement learning) is supported or not may be included. During the WTRU capability exchange process between the WTRU and the network, an indicator of whether reporting the trained OTA pre-equalizer is supported or not may be included. During the WTRU capability exchange process between the WTRU and the network, an indicator of whether selecting an OTA pre-equalizer (e.g., from a library of OTA pre-equalizers at the WTRU) is supported or not may be included.

Through the WTRU capability exchange process (e.g., as described herein), the combiner node may know the capability (ies) of the WTRU to support online learning of OTA combiner. For a WTRU that is capable of supporting such a function and/or feature (e.g., transmitting uplink (e.g., training) data for online learning of OTA combiner), the WTRU may receive one or more configuration information and/or parameters configured by the combiner node. The WTRU may receive configuration for reporting the performance of an AI/ML model. The WTRU may receive configuration for reporting the local training data information (e.g., size, quality, diversity). The WTRU may receive configuration for reporting the downlink channel estimate statistics. The WTRU may receive configuration for receiving an uplink scaling factor.

The WTRU may receive configuration for generating the (e.g., uplink) training data for online learning of OTA combiner. Examples of (e.g., uplink) training data may include: analog PRD (e.g., analog AI/ML model parameter(s); and/or digital PRD (e.g., quantized AI/ML model parameter(s), QAM symbol(s). The configuration for generating the (e.g., uplink) training data for online learning of OTA combiner may include the seed of the PRD. The WTRU may receive configuration on how to perform uplink pre-equalization (e.g., AI/ML-based OTA pre-equalizer, phase correction, channel inversion).

The WTRU may receive configuration about how to map the (e.g., uplink) training data to the uplink resources. The uplink resource allocation(s) for online learning of OTA combiner to transmit the uplink signal determined by using one or more of: the configured uplink scaling factor, uplink pre-equalization technique, and/or (e.g., uplink) training data. FIG. 8 depicts an example, where each participating WTRU may may its own uplink data to the same uplink resource (e.g., PRBs and/or RBs). The (e.g., uplink) training data symbols from each WTRU may be transmitted in the OTA-FL manner.

The WTRU may receive configuration for (e.g., uplink) OTA-RS. The uplink OTA-RS may target improving the (e.g., uplink) channel estimation accuracy per RE level. The (e.g., uplink) OTA-RS may be orthogonal known pilot sequences. The (e.g., uplink) OTA-RS may have a higher density than one or more (e.g., uplink) reference signals (e.g., SRS, DMRS). The (e.g., uplink) OTA-RS density in frequency-domain may be based on delay spread. The (e.g., uplink) OTA-RS density in time-domain may be based on WTRU speed. Examples of (e.g., uplink) OTA-RS allocations may include one or more of the following. In examples, (e.g., uplink) OTA-RS allocations for each WTRU may be orthogonal in time, frequency, and/or code domain (e.g., similar to DMRS and/or SRS), while OTA-RS may be with higher density than a DMRS and/or a SRS. In examples, (e.g., uplink) OTA-RS allocations for each WTRU may be partially and/or fully overlapping in time domain and/or frequency domain and/or code domain to reduce RS overhead. In examples, (e.g., uplink) OTA-RS allocations for each WTRU may be multiplexed with (e.g., uplink) data (e.g., PRD during online learning of OTA combiner). The (e.g., uplink) OTA-RS allocations may be a part of the (e.g., uplink) resource allocation for online learning of the OTA combiner.

The WTRU may receive configuration for (e.g., downlink) OTA-RS. The (e.g., downlink) OTA-RS may target improving the (e.g., downlink) channel estimation accuracy per RE level. The (e.g., downlink) OTA-RS may be orthogonal known pilot sequences. The (e.g., downlink) OTA-RS may have a higher density than one or more other reference signals (e.g., CSI-RS). The (e.g., downlink) OTA-RS density in frequency-domain may be based on delay spread. The (e.g., downlink) OTA-RS density in time-domain may be based on WTRU speed. Examples of OTA-RS (e.g., downlink) allocation(s) may include one or more of the following. In examples, (e.g., downlink) OTA-RS allocation(s) for each WTRU may be orthogonal in time, frequency, and/or code domain (e.g., similar to CSI-RS), while (e.g., downlink) OTA-RS may include higher density (e.g., than CSI-RS). In examples, (e.g., downlink) OTA-RS allocation(s) for each WTRU may be partially and/or fully overlapping in time, frequency, and/or code domain to reduce RS overhead. In examples, (e.g., downlink) OTA-RS allocation(s) for each WTRU may be multiplexed with downlink data.

The WTRU may receive configuration for participating in online learning of OTA pre-equalizer. Online learning of OTA pre-equalizer may be periodic, aperiodic, and/or semi-persistent. The configuration for participating in online learning of OTA pre-equalizer may include a training method (e.g., supervised learning and/or reinforcement learning). The configuration for participating in online learning of OTA pre-equalizer may include the configuration for receiving the gradient(s) of end-to-end loss (e.g., mean square error of OTA aggregation) with respect to the (e.g., estimated) uplink channel. The configuration for participating in online learning of OTA pre-equalizer may include the configuration for receiving one or more OTA aggregation performance metrics (e.g., OTA aggregation error, NMSE, AI/ML model performance, etc.). The configuration for participating in online learning of OTA pre-equalizer may include the training related information. The training related information may include one or more of the following. The training related information may include the learning algorithm, learning rate(s), regularization parameters, etc. The training related information may include the total number of training iterations for each training round. The training related information may include a loss function (e.g., binary cross entropy, mean square error). The training related information may include one or more thresholds to monitor the AI/ML model training progress. The configuration for participating in online learning of OTA pre-equalizer may include the configuration for reporting the trained OTA pre-equalizer.

One or more of the following signals may be included for a WTRU and/or a combiner node (e.g., node that determines the OTA combiner, network-side, controller WTRU, etc.) to participate in online learning of OTA combiner. A request to report the AI/ML capability (ies) transmitted from the combiner node to the WTRU may be included for participation in online learning of OTA combiner. Reporting the AI/ML capability (ies) transmitted from the WTRU to the combiner node. Reporting the performance of a first (e.g., locally trained AI/ML model transmitted from the WTRU to the combiner node may be included for participation in online learning of OTA combiner. A local training data information message (e.g., size, quality, diversity of local data) transmitted from the WTRU to the combiner node may be included for participation in online learning of OTA combiner. The message on downlink channel estimate statistics transmitted from the WTRU to the combiner node may be included for participation in online learning of OTA combiner. An indication to initiate online learning of OTA combiner transmitted from the combiner node to the WTRU may be included for participation in online learning of OTA combiner. Configuration for uplink resource allocations for online learning of OTA combiner transmitted from the combiner node to the WTRU may be included for participation in online learning of OTA combiner. Configuration for uplink OTA-RS transmitted from the combiner node to the WTRU may be included for participation in online learning of OTA combiner. Uplink OTA-RS transmitted from the WTRU to the combiner node may be included for participation in online learning of OTA combiner. Configuration for downlink OTA-RS transmitted from the combiner node to the WTRU may be included for participation in online learning of OTA combiner. Downlink OTA-RS transmitted from the combiner node to the WTRU may be included for participation in online learning of OTA combiner. Configuration for generating the (e.g., uplink) training data for online learning of OTA combiner transmitted from the combiner node to the WTRU may be included for participation in online learning of OTA combiner. Configuration for uplink pre-equalization transmitted from the combiner node to the WTRU may be included for participation in online learning of OTA combiner. Configuration for uplink scaling factor transmitted from the combiner node to the WTRU may be included for participation in online learning of OTA combiner. Information about the WTRU group participating in OTA-FL training round(s) (e.g., WTRU group distribution) transmitted from the combiner node to the WTRU may be included for participation in online learning of OTA combiner. An uplink signal through the uplink resources allocated for online learning of OTA combiner, using one or more of: the configured uplink scaling factor, uplink pre-equalization technique, and/or (e.g., uplink) training data transmitted from the WTRU to the combiner node may be included for participation in online learning of OTA combiner. A message indicating the training of OTA combiner is complete transmitted from the combiner node to the WTRU may be included for participation in online learning of OTA combiner. Configuration for online learning of OTA pre-equalizer transmitted for the combiner node to the WTRU may be included for participation in online learning of OTA combiner. For example, one or more of the following may be included: a training method transmitted from the combiner node to the WTRU; one or more gradients of end-to-end loss (e.g., mean square error of OTA aggregation) with respect to the estimated uplink channel transmitted from the combiner node to the WTRU; one or more OTA aggregation performance metrics (e.g., OTA aggregation error, NMSE, AI/ML model performance, etc.) transmitted from the combiner node to the WTRU; a message indicating the training of OTA pre-equalizer is complete transmitter from the combiner node to the WTRU; a message indicating the training of OTA pre-equalizer is complete transmitted from the WTRU to the combiner node; configuration for reporting the trained OTA pre-equalizer transmitted from the combiner node to the WTRU; and/or the trained OTA pre-equalizer transmitted from the WTRU to the combiner node.

The procedures for online learning of OTA combiner may be described herein. Procedures for the transmitter node (e.g., WTRU) and/or procedures for the combiner node may be disclosed here (e.g,, as shown in FIGS. 10 and 11, respectively). The combiner node and/or network can refer to one or more (e.g., any) node in the network (e.g., network, gNB, another WTRU (e.g., sidelink, WTRU-to-WTRU direct communication), etc.).

A WTRU may indicate to a combiner node (e.g., the network) an AI/ML function it wants to acquire through FL. The WTRU may indicate if it has a first (e.g., locally trained) AI/ML model. The WTRU may indicate the performance of the first AI/ML model. The WTRU may report the local training data information (e.g., size, quality, diversity, etc.) to the combiner node. The WTRU(s) participating in OTA-FL training round(s) may (e.g., simultaneously) transmit the first AI/ML model parameter(s) (e.g., gradients, weights, bias), over the same time and/or frequency resource elements for OTA aggregation(s). The WTRU and/or WTRU group may receive a second (e.g., global) AI/ML model (and/or a part of a second AI/ML model) from the combiner node. The first (e.g., locally trained) and/or second (e.g., global) AI/ML model may have a common neural network architecture to perform the same and/or similar function(s).

The WTRU may be triggered (e.g., may detect a need) to initiate online learning of OTA combiner.

The WTRU and/or WTRU group may be configured (e.g., through radio resource control (RRC) signaling) to participate in online learning of OTA combiner. The training for OTA combiner can be periodic, aperiodic, and/or semi-persistent. The activation and/or deactivation of the configured training may be signaled by DCI and/or MAC-CE.

The WTRU may be configured (e.g., through RRC signaling) to transmit an (e.g., uplink) training data (e.g., pseudo-random data (PRD)) during online learning of OTA combiner. Examples of (e.g., uplink) training data may include analog PRD (e.g., analog AI/ML model parameter(s)), digital PRD (e.g., quantized AI/ML model parameter(s), quadrature amplitude modulation (QAM) symbol(s)), and/or the like. The WTRU may be signaled with the seed of PRD generator by the network. The WTRU may receive uplink resource allocation(s) for transmitting the (e.g., uplink) training data. One or more (e.g., all) WTRUs (e.g., participating in online learning of OTA combiner) may use the same uplink resources (e.g., physical resource blocks (PRBs) and/or resource blocks (RBs)) to transmit the (e.g., uplink) training data (e.g., PRD).

The WTRU may be configured to transmit an uplink reference signal (RS) (e.g., uplink OTA-RS). The WTRU may receive the uplink OTA-RS allocation(s) as a part of the uplink resource allocation for online learning of the OTA combiner. In examples, uplink OTA-RS allocation(s) for each WTRU may be orthogonal in time and/or frequency and/or code domain (e.g., similar to physical uplink shared channel (PUSCH) demodulation reference signal (DMRS) and/or sounding RS (SRS)), while uplink OTA-RS may be with density than PUSCH DMRS and/or SRS. In examples, uplink OTA-RS allocation(s) for each WTRU may be partially and/or fully overlapping in time and/or frequency and/or code domain to reduce RS overhead. In examples, uplink OTA-RS allocation(s) for each WTRU may be multiplexed with uplink data (e.g., PRD during online learning of OTA combiner). Uplink OTA-RS resource elements (REs) may be used for uplink channel sounding (e.g., determining the uplink scaling factor) such as SRS. Uplink OTA-RS REs may be used for channel estimation for demodulation (e.g., for combining the received OTA aggregated signals at each receive antenna in OTA-FL training) such as PUSCH DMRS.

The WTRU may transmit uplink OTA-RS to the combiner node.

The WTRU may receive a configuration message. The configuration message may include an uplink scaling factor. The configuration message may include an uplink pre-equalization technique (e.g., no pre-equalization, phase correction, channel inversion, AI/ML-based OTA Pre-Equalizer, etc.). The configuration message may include OTA combining technique at the combiner node (e.g., MRC, AI/ML model #1,AI/ML model #2,etc.). The configuration message may include information about the WTRU group participating to OTA-FL training round(s) (e.g., WTRU group distribution).

The WTRU and/or WTRU group (e.g., each WTRU included in the WTRU group) may transmit an uplink signal through the uplink resources allocated for online learning of OTA combiner, for example, using one or more of: the configured uplink scaling factor, an uplink pre-equalization technique, and/or (e.g., uplink) training data (e.g., PRD).

The WTRU may be configured to perform online learning of OTA pre-equalizer.

The WTRU may be configured to train OTA pre-equalizer through supervised learning. The WTRU may receive the gradient(s) of end-to-end loss (e.g., mean square error of OTA aggregation) with respect to the (e.g., estimated) uplink channel. The WTRU may apply the differentiation chain rule for computing the gradients with respect to the OTA pre-equalizer. The WTRU may train OTA pre-equalizer through supervised learning.

The WTRU may be configured to train OTA pre-equalizer through reinforcement learning. The WTRU may receive one or more OTA aggregation performance metrics (e.g., OTA aggregation error, NMSE, AI/ML model performance, etc.) as a reward. The WTRU may train OTA pre-equalizer through reinforcement learning. The reinforcement learning agent at the WTRU may take action to update the OTA pre-equalizer based on the received reward(s).

The WTRU may perform the online learning of OTA pre-equalizer according to the configuration. The WTRU may report the trained OTA pre-equalizer to the combiner node. The WTRU may store one or more (e.g., multiple) AI/ML models for OTA pre-equalizer (e.g., a library of OTA pre-equalizers). The WTRU may select an OTA pre-equalizer (e.g., from a library of OTA pre-equalizers trained at the WTRU based on the received configuration message (e.g., WTRU group distribution). The WTRU may be configured to receive a downlink reference signal (e.g., downlink OTA-RS).

The WTRU may receive a training complete message from the combiner node.

Embodiments described herein include methods and/or procedures for a combiner node (e.g., as depicted in FIG. 11, a node that may determine OTA combiner). For example, a combiner node may be and/or include a network and/or a controller WTRU.

The combiner node may be triggered (e.g., detect a need) to initiate online learning of OTA combiner. Triggers to initiate the online learning of OTA combiner may include performance monitoring of AI/ML based OTA combiner and/or the WTRU feedback during OTA-FL training rounds. WTRU feedback may include local performance of the second (e.g., global) AI/ML model received by the combiner node.

The combiner node may configure a WTRU and/or WTRU group (e.g., through RRC signaling) to participate in online learning of OTA combiner. The training for OTA combiner can be periodic, aperiodic, and/or semi-persistent. The activation and/or deactivation of the configured training may be signaled by DCI and/or MAC-CE.

The combiner node may configure the WTRU group (e.g., each WTRU in the WTRU group) (e.g., through RRC signaling) to transmit an (e.g., uplink) training data signal (e.g., PRD) during online learning of OTA combiner. Examples of (e.g., uplink) training data may include analog PRD (e.g., unquantized AI/ML model parameter(s), etc.). Examples of (e.g., uplink) training data may include digital PRD (e.g., quantized AI/ML model parameter(s), QAM, etc.). The combiner node may signal with the seed of PRD. The combiner node may re-generate the PRD through the corresponding seed. The combiner node may use the PRD as ground-truth label during online learning of OTA combiner.

The combiner node may configure the WTRU group (e.g., each WTRU in the WTRU group) to transmit an uplink reference signal (e.g., uplink OTA-RS). The combiner node may use the received uplink signal for one or more of: uplink channel sounding (e.g., determining the uplink scaling factor) such as SRS; and/or channel estimation for demodulation (e.g., for combining the received OTA aggregated signals at each receive antenna in OTA-FL training) such as PUSCH DMRS.

The combiner node may receive one or more uplink reference signals (e.g., OTA-RS).

The combiner node may signal a configuration message to the WTRU group (e.g., to each WTRU in the WTRU group). The configuration message may include one or more of: an uplink scaling factor, an uplink OTA pre-equalization technique, OTA combining technique at the combiner node, and/or the information about the WTRU group participating in OTA-FL training round(s).

The combiner node may receive one or more (e.g., uplink) training data signals.

The combiner node may train an AI/ML-based OTA combiner, for example, by using one or more of: the one or more received (e.g., uplink) training data signals, the estimated uplink channel for OTA combiner (e.g., through the received uplink OTA-RS and/or DMRS), and/or (e.g., uplink) training data (e.g., ground-truth label) through supervised learning.

The combiner node may configure a WTRU group (e.g., each WTRU in the WTRU group) to perform online learning of OTA pre-equalizer. The combiner node may send one or more of: the gradients of end-to-end loss (e.g., mean square error of OTA aggregation) with respect to the (e.g., estimated) uplink channel; and/or OTA aggregation performance metric(s) (e.g., OTA aggregation error, NMSE, AI/ML model performance, etc.). The combiner node may configure a WTRU group (e.g., each WTRU in the WTRU group) for reporting the trained OTA pre-equalizer. The combiner node may configure a WTRU group (e.g., each WTRU in a WTRU group) to receive a downlink reference signal (e.g., downlink OTA-RS). The downlink OTA-RS may be used as the input to the AI/ML-based OTA pre-equalizer. The downlink OTA-RS may target improving the downlink channel estimation accuracy per RE level.

The combiner node may send a training complete message (e.g., when OTA combiner is sufficiently trained and/or when OTA combiner achieves a target OTA aggregation error).

FIG. 10 depicts an example of WTRU procedure(s) for online learning of OTA combiner 1000. At 1002, a WTRU may indicate to a combiner node an AI/ML function it wants to acquire through FL. At 1004, the WTRU may be triggered (e.g., may detect a need) to initiate online learning of OTA combiner. At 1006, the WTRU may be configured to participate in online learning of OTA combiner. At 1008, the WTRU may be configured to transmit (e.g., uplink) training data during online learning of OTA combiner. At 1010, the WTRU may be configured to transmit an uplink reference signal (e.g., uplink OTA-RS). At 1012, the WTRU may transmit uplink one or more OTA-RSs to the combiner node. At 1014, the WTRU may receive a configuration message. The configuration message may include one or more of: an uplink scaling factor, an uplink pre-equalization technique, an OTA combining technique at the combiner node, and/or information about the WTRU group participating in OTA-FL training round(s). At 1016, the WTRU (and/or WTRU group) may transmit an uplink signal through the uplink resources allocated for online learning of OTA combiner, using one or more of: the configured uplink scaling factor, an uplink pre-equalization technique, and/or (e.g., uplink) training data (e.g., PRD). At 1018, the WTRU may be configured to perform online learning of OTA pre-equalizer. At 1020, the WTRU may receive a training complete message from the combiner node.

FIG. 11 depicts an example flow chart diagram of combiner node procedures for online learning of OTA combiner 1100. At 1102, the combiner node may be triggered to initiate online learning of OTA combiner. At 1104, the combiner node may configure a WTRU group to participate in online learning of OTA combiner. At 1106, the combiner node may configure the WTRU group to transmit an (e.g., uplink) training data signal (e.g., PRD) during online learning of OTA combiner. At 1108, the combiner node may configure the WTRU group to transmit an uplink reference signal (e.g., uplink OTA-RS). At 1110, the combiner node may receive one or more uplink reference signals (e.g., uplink OTA-RSs). At 1112, the combiner node may signal a configuration message to the WTRU group. The configuration message may include one or more of: an uplink scaling factor, an uplink pre-equalization technique, an OTA combining technique at the combiner node, and/or information about the WTRU group participating in OTA-FL training round(s). At 1114, the combiner node may receive one or more (e.g., uplink) training data signals. At 1116, the combiner node may train an OTA combiner by using one or more of: the one or more received (e.g., uplink) training data signals, estimated uplink channel and/or (e.g., uplink) training data (e.g., ground-truth label) through supervised learning, for example. At 1118, the combiner node may configure a WTRU group to perform online learning of OTA pre-equalizer. At 1120, the combiner node may send a training complete message to the WTRU group.

Numerical results may be described herein for the performance evaluation of the embodiments described herein with respect to online learning of OTA combiner. Simulations may be performed by using Sionna, which is an open-source Python library for the wireless simulations based on TensorFlow. The channels may be generated through Sionna Ray Tracing (RT).

Table 1 outlines one or more simulation parameters. The Munich scene available in Sionna RT may be utilized for channel generation. In Sionna RT, this scene may include the area around Frauenkirche in Munich, Germany, which may be created through OpenStreetMap, Blender, and/or Mitsuba Blender. For example, the number of WTRUs may be, 2, 4, and/or 8. The number of gNBs may be one. The number of transmission antennas may be 1. The number of reception antennas may be 2, 4, 8, 16, 32, 64, and/or 128. The channel model may be generated through Sionna Ray Tracing: scene may be Munich; max depth may be five; line of sight (LOS) may be true; synthetic array may be false; specular reflection may be true; diffuse reflection may be false; refraction may be true; normalize may be false; and/or normalize delays may be true. WTRU speed may be 3 kilometers per hour. Maximum Tx power (e.g., uplink) may be 10 dBm. Noise PSD may be −174 dBm/Hz. Noise figure may be 6 dB. Channel bandwidth may be 10 MHz (52 RBs with 15 kHz SCS). Subcarrier spacing may be 15 kHz. Precoding technique(s) at WTRU may not be applicable (e.g., only uplink power scaling). Combining technique(s) at gNB may be AI/ML-based combiner and/or MRC. PRD may be and/or include 16-QAM.

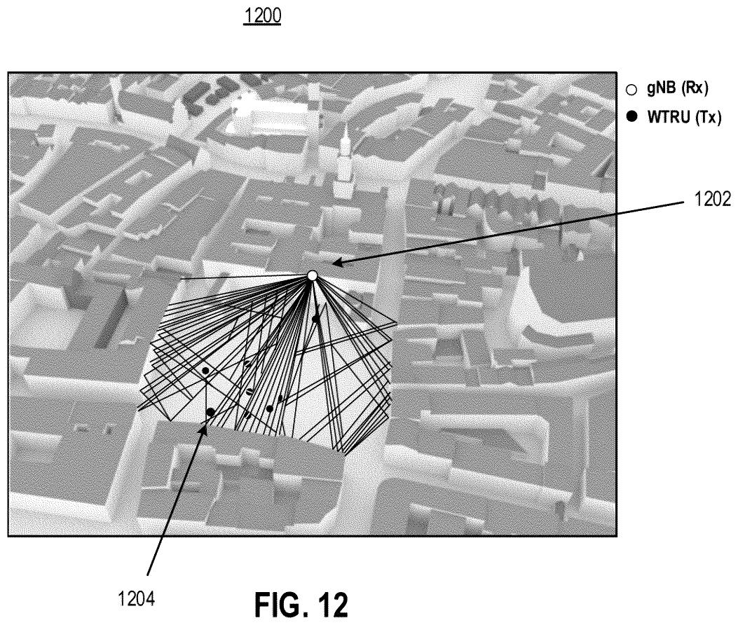

FIG. 12 illustrates an example visualization of Munich scene with ray-traced paths through Sionna RT 1200, where the ray-traced paths may exist 8 WTRUs and 1 gNB. For example, FIG. 12 may depict a gNB 1202 and one or more WTRUs (e.g., WTRU 1204). As expressed in Table 1, the number of single-antenna WTRUs may be (e.g., assumed to be) 2, 4, and/or 8. Additionally or alternatively, the number of antennas at the gNB can be 2, 4, 8, 16, 32, 62, and/or 128. The (e.g., uplink) training data for online learning of OTA combing may be generated through digital pseudo random data symbols through 16-QAM.

TABLE 1
Simulation parameters

| # of UEs | # of gNB | [2, 4, 8] | 1 |
|---|---|---|---|
| # of Tx Ant | # of Rx Ant | 1 | [2, 4, 8, 16, 32, 64, 128] |
| Channel Model | | Sionna Ray Tracing | |
| | | scene = Munich | |
| | | max_depth = 5 | |
| | | los = True | |
| | | synthetic_array = False | |
| | | specular_reflection = True, | |
| | | diffuse_reflection = False, | |
| | | refraction = True | |
| | | normalize = False | |
| | | normalize_delays = True | |
| UE Speed | | 3 km/h | |
| Maximum Tx Power (Uplink) | | 10 dBm | |
| Noise PSD | Noise Figure | −174 dBm/Hz | 6 dB |

| | |
|---|---|
| Channel Bandwidth | 10 MHz (52 RBs with 15 KHz SCS) |
| Subcarrier Spacing | 15 kHz |
| Precoding Techniques @ UE | N/A (Only Uplink Power Scaling) |
| Combining Techniques @ | Al/ML-based Combiner |
| gNB | Maximum Ratio Combiner (Legacy) |
| Pseudo-Random Data (PRD) | 16-QAM |

The OTA aggregation performance of MRC as the other (e.g., legacy, non-AI/ML) technique may be (e.g., firstly) evaluated. Numerical results may reflect a limited MRC performance in comparison to the effectiveness of the embodiments described herein with respect to the AI/ML-based OTA combiner.

Table 2 depicts the parameters related to the AI/ML model training. The dataset may be developed by generating ray-traced channel samples through Sionna RT. The dataset may include 17.46M channel samples. In each slot, the channel may include 14 OFDM symbols and/or 624 subcarriers based on OFDM resource grid. It may represent 14×624=8,736 channel samples per slot. 2,000 slots worth of channels may be generated. The data may be split as: 80% training; 15% validation; 5% test. The optimizer may be Adam. The learning rate may be set to 0.0002 and/or the learning rate scheduler may be used. The batch size may be 32. The number of model parameters may be 98,610. The loss function may be mean square error.

The AI/ML model architecture (e.g., as shown in FIG. 7) may be utilized for OTA combiner. The training of AI/ML model for OTA combiner may be performed (e.g., as described herein, as shown in FIG. 8). A particular AI/ML model may be trained for each WTRU group distribution. The model generalization may be tested (e.g., when the AI/ML-based OTA combiner is trained for the first WTRU group distribution, how it performs for the second WTRU group distribution, and vice versa).

TABLE 2
Parameters on Al/ML model training

| | |
|---|---|
| Dataset Size | 17.46M channel samples: |
| | In each slot, the channel includes 14 OFDM Symbols |
| | and 624 subcarriers based on OFDM resource grid. It |
| | represents 14 × 624 = 8,736 channel samples per slot. |
| | 2000 slots worth of channel is generated. |
| Dataset Split | 80% Training \| 15% Validation \| 5% Test |
| Optimizer | Adam |
| Learning Rate | 0.0002 + Learning Rate Scheduler |
| Batch Size | 32 |
| Model Params | 98,610 |
| Loss Function | Mean square error |

Training with a single WTRU group distribution may be described herein. The OTA combiner may be (e.g., only) trained for a particular geometric WTRU group distribution.

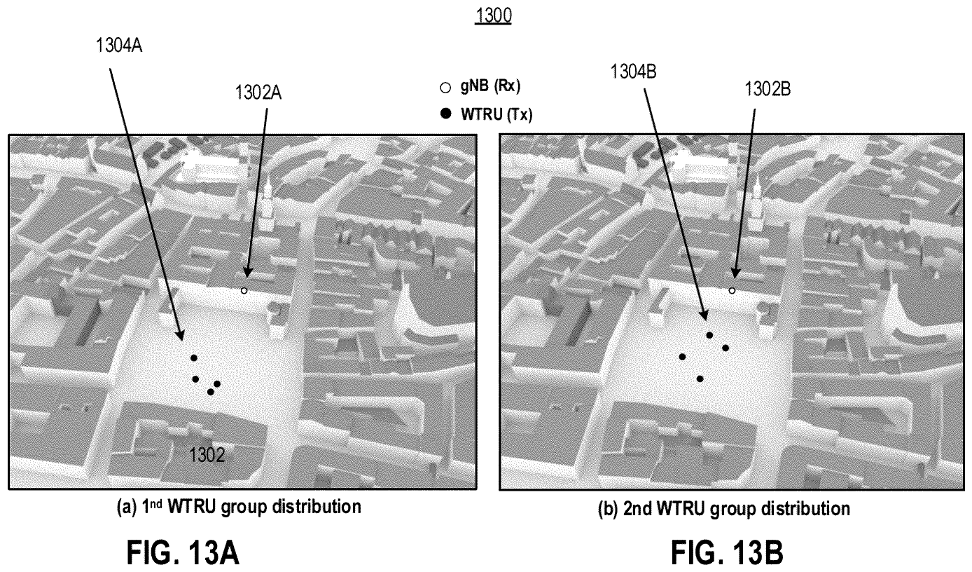

FIGS. 13A and 13B 1300 may demonstrate the first WTRU group distribution and the second WTRU group distribution, respectively. For example, FIG. 13A may depict a gNB 1302A and one or more WTRUs (e.g., WTRU 1304A). For example, FIG. 13B may depict a gNB 1302B and one or more WTRUs (e.g., WTRU 1304B). For each WTRU group distribution, 1000 consecutive slots worth of channel may be generated. Since the subcarrier spacing is 15 kHz, for example, the slot duration may be 1 ms and 1000 slots may imply 1s duration of channel generation. Additionally or alternatively, in each slot, the channel may include 14 OFDM symbols and/or 624 subcarriers based on OFDM resource grid (e.g., 14×624=8,736 channel samples per slot). The dataset for each WTRU group distribution may include 8,73M samples.

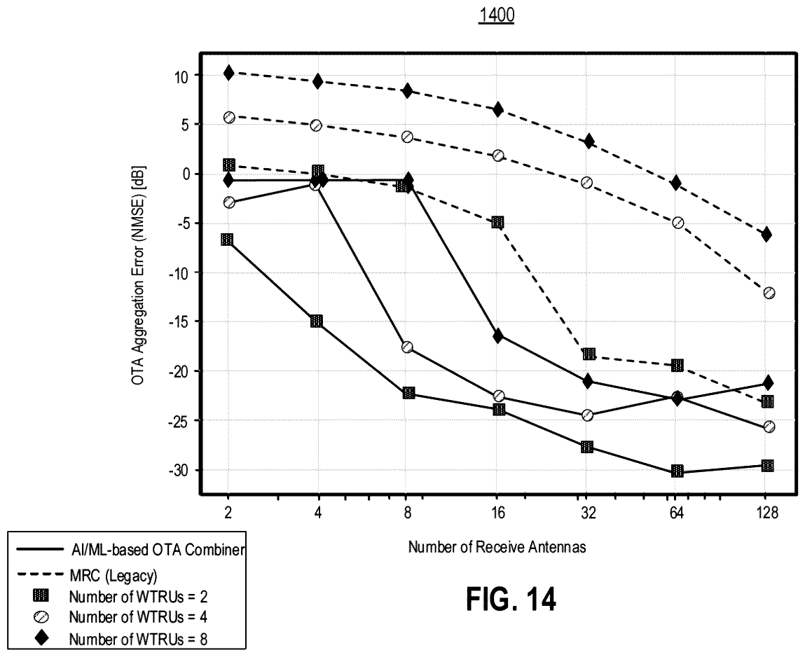

FIG. 14 depicts an example test performance for AI/ML-based OTA combiner and/or MRC 1400. FIG. 14 may compare the OTA aggregation performance of the embodiments described herein with respect to AI/ML-based OTA combiner with the OTA aggregation performance of MRC. The OTA aggregation performance in the test dataset may be plotted versus the number of receiver antennas at gNB. In FIG. 14, AI/ML model for OTA combiner may (e.g., only) be trained and/or tested for the first WTRU group distribution dataset. The number of WTRUs participating in the OTA transmission(s) (e.g., using the same uplink resources for the (e.g., uplink) transmission(s) may be considered as 2, 4, and/or 8. The OTA aggregation error may be calculated by using the NMSE metric (e.g., as expressed in Equation 5). The numerical results may show that the increasing number of WTRUs leads to high interference for the (e.g., conventional) MRC (e.g., as Equation 3 may depict), which may deteriorate OTA aggregation accuracy (e.g., increases the OTA aggregation error). The AI/ML-based OTA combiner may (e.g., successfully) learn how to combine the received signals and/or may (e.g., greatly) reduce the OTA aggregation error. For example, when gNB has 32 receive antennas to support 4 WTRUs, the AI/ML-based OTA combiner may achieve −28 dB NMSE, while MRC may provide (e.g., only) −1 dB NMSE (e.g., a 27 dB improvement in OTA aggregation error).

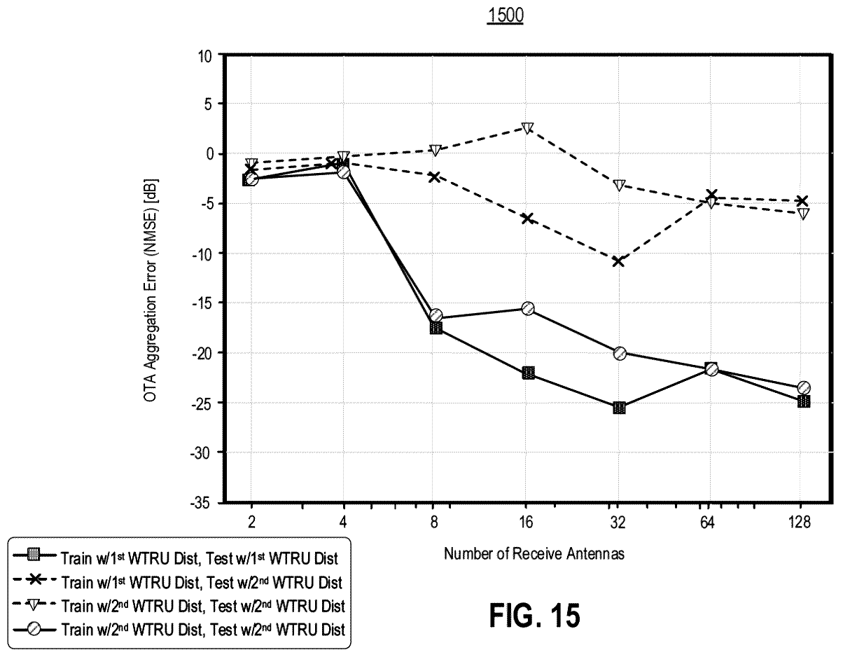

FIG. 15 depicts an example of training and test performance of OTA combiner for first and second WTRU group distributions 1500. FIG. 15 depicts the test performance of two AI/ML models (e.g., Model #1 may be trained for the first WTRU group distribution and/or Model #2 may be trained for the second WTRU group distribution). The numerical results may show that when a model is trained and/or tested on the same WTRU group distribution, it may improve the OTA aggregation quality. When the AI/ML model is trained for the first WTRU group distribution and tested for the second WTRU group distribution (and/or vice versa), high OTA aggregation error may be observed. It may imply the requirement of online learning of OTA combiner for adapting to the dynamic channel conditions and/or WTRU group distributions.

Training with one or more (e.g., multiple) WTRU group distributions for model generalization may be described herein. 2000 slots may be regenerated in the dataset for one or more (e.g., multiple) group distributions. The WTRUs may be randomly distributed for each sot for the purpose of dataset diversity and/or model generalization. The dataset size may remain as in Table 2 (e.g., 17.46M channel samples), for example, since 2000 slots may be generated. As Table 2 depicts, the dataset may be split as 80% for training (e.g., 1600 slots), 15% for validation (e.g., 300 slots), and/or 5% for test (e.g., 100 slots).

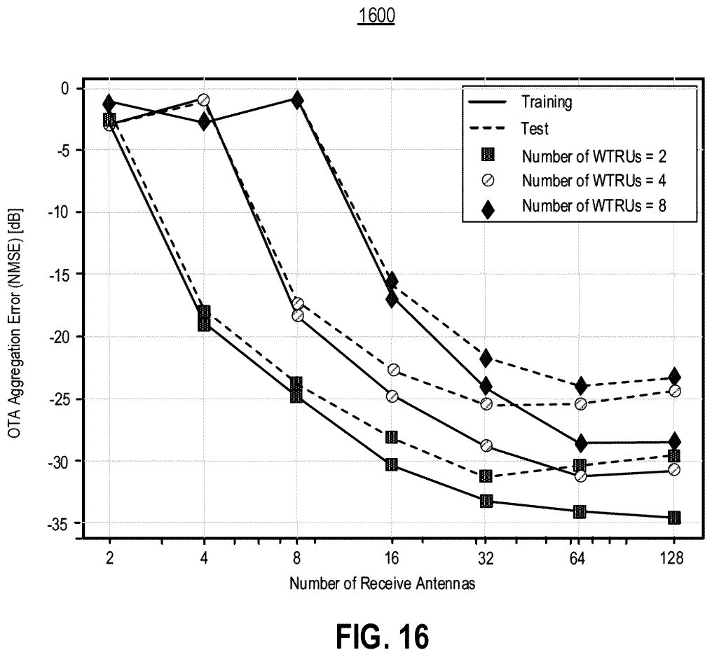

FIG. 16 depicts the training and/or test performance of the embodiments described herein with respect to AI/ML-based OTF combiner 1600. Unlike FIG. 15 (e.g., training with a single WTRU group distribution), for example, training with one or more (e.g., multiple) WTRU group distributions may include reducing the gap between the training and test performance. Additionally or alternatively, it may include model generalization, for example, since the training and/or test samples may be generated by randomly distributing the WTRU groups.

Embodiments described herein may include performance monitoring of OTA combiner. When AI/ML-based OTA combiner is learned (e.g., based on achieving a target OTA aggregation error), for example, it can be used during inference (e.g., OTA-FL training rounds). The performance of the AI/ML-based OTA combiner may degrade over the time, for example, based on one or more (e.g., several) reasons. For example, the distribution of the WTRU group participating in OTA-FL training may vary during the training rounds. Although the trained AI/ML model for OTA combiner can be optimal for the initial WTRU group distribution, another (e.g., the new) WTRU group distribution can make it sub-optimal based on, for example, the variations in channel condition(s) and/or channel quality. The performance monitoring of OTA combiner may include and/or enable one or more of the following: continue using the existing AI/ML model, fall back to another (e.g., legacy, non-AI/ML) technique (e.g., MRC), and/or (re)-training and/or fine-tuning the AI/ML-based OTA combiner based on experiencing the performance degradation. The embodiments described herein may include procedures for the performance monitoring of AI/ML-based OTA combiner.

Embodiments described herein may be applicable for one or more (e.g., any) applications aiming to combine the synchronized transmission(s) (e.g., over the same radio resources), where each transmission by a particular transmitter may correspond to a common parameter at the receiver. The common parameter may correspond to data having the same value, such as a common QAM symbol on the same radio resource in an OFDM time-frequency grid, and/or may correspond to analog signal(s) (e.g., real, complex) related by a common statistic (e.g., many temperature measurements where the receive is tasked to compute the mean temperature), and/or may correspond to a common parameter in an AI/ML model architecture shared by the transmitter(s), such as in OTA-FL. The receiver with one or more (e.g., multiple) antennas may target (e.g., successively) combining the one or more (e.g., multiple) received signals at each antenna. The combiner at the receiver may (e.g., also) have one or more (e.g., various) objectives (e.g., summation as in OTA-FL (e.g., see Equation 2 and/or Equation 5), weighted summation, majority vote, geometric mean, polynomial function, etc.). OA-FL may be used as an example application for the one or more embodiments described herein.

The network (and/or combiner node) may initiate the WTRU capability exchange process, for example, by sending the UECapabilityEnquiry RRC message to the WTRU. This message may be used to request (e.g., specific) information regarding the capability (ies) of the WTRU. The network may include parameter(s) in this message to specify which capability (ies) it is interested in. Embodiments described herein may include a network specifying parameters related to the capability (ies) of the WTRU to support performance monitoring of the OTA combiner in UECapabilityEnquiry message (e.g., the capability of transmitting OTA performance monitoring feedback, etc.).

Upon receiving the UECapabilityEnquiry RRC message, for example, the WTRU may respond with the UECapabilityInformation RRC message (e.g., accordingly). This message may include (e.g., detailed) information about the capability (ies) of the WTRU in supporting performance monitoring of OTA combiner. During the WTRU capability exchange process between the WTRU and the network, one or more of the following parameters may be included. During the WTRU capability exchange process between the WTRU and the network, an indicator of whether supporting OTA-FL is supported or not may be included. During the WTRU capability exchange process between the WTRU and the network, an indicator of whether transmitting AI/ML capability (ies) is supported or not may be included. During the WTRU capability exchange process between the WTRU and the network, an indicator of whether the first (e.g., locally trained) AI/ML model may be present at the WTRU or not may be included. During the WTRU capability exchange process between the WTRU and the network, an indicator of whether reporting the local training data information (e.g., size, quality, diversity) is supported or not may be included. During the WTRU capability exchange process between the WTRU and the network, an indicator of whether transmitting the first (e.g., locally trained) AI/ML model parameter(s) (e.g., gradients, weights, bias) is supported or not may be included. During the WTRU capability exchange process between the WTRU and the network, an indicator of whether receiving the second (e.g., global) AI/ML model is supported or not may be included. During the WTRU capability exchange process between the WTRU and the network, an indicator of whether testing the received second (e.g., global) AI/ML model) (e.g., through the local dataset) is supported or not may be included. During the WTRU capability exchange process between the WTRU and the network, an indicator of whether receiving an OTA performance monitoring configuration message is supported or not may be included. During the WTRU capability exchange process between the WTRU and the network, an indicator of whether using AI/ML model performance threshold (e.g., 50% accuracy in a classification use case) is supported or not may be included. During the WTRU capability exchange process between the WTRU and the network, an indicator of whether using AI/ML model performance update threshold (e.g., the performance difference between the first and second AI/ML models) is supported or not may be included. During the WTRU capability exchange process between the WTRU and the network, an indicator of whether using AI/ML model update threshold (e.g., the delta between the first (e.g., locally trained) and second (e.g., global) AI/ML model parameters) is supported or not may be included. During the WTRU capability exchange process between the WTRU and the network, an indicator of whether transmitting OTA performance monitoring feedback (e.g., determined using the OTA performance monitoring configuration) is supported or not may be included.

Through the WTRU capability exchange process (e.g., as described herein), the combiner node may know the capability (ies) of the WTRU to support the performance monitoring of OTA combiner. For a WTRU that is capable of supporting such a function and/or feature, it may receive one or more of the following parameters configured by the combiner node: the configuration for reporting the performance of a first (e.g., locally trained) AI/ML model; the configuration for reporting the local training data information (e.g., size, quality, diversity); the configuration about how the first (e.g., locally trained) AI/ML model parameters may be transmitted in OTA-FL manner; the configuration for receiving the second (e.g., global) AI/ML model; the configuration for testing the second (e.g., global) AI/ML model (e.g., through the local dataset); the configuration for OTA performance monitoring; and/or the configuration for transmitting OTA performance monitoring feedback.

One or more of the following signals may be included for a WTRU to support performance monitoring of OTA combiner. A request to report the AI/ML capability (ies) transmitted from the combiner node to the WTRU may be included WTRU to support performance monitoring of OTA combiner. Reporting the AI/ML capability (ies) transmitted from the WTRU to the combiner node may be included to support performance monitoring of OTA combiner. Reporting the performance of a first (e.g., locally trained AI/ML model transmitted from the WTRU to the combiner node may be included to support performance monitoring of OTA combiner. A local training data information message (e.g., size, quality, diversity of local data) transmitted from the WTRU to the combiner node may be included to support performance monitoring of OTA combiner. Configuration for transmitting the first (e.g., locally trained) AI/ML model parameter(s) in OTA-FL manner transmitted from the combiner node to the WTRU may be included to support performance monitoring of OTA combiner. The first (e.g., locally trained) AI/ML model transmitted from the WTRU to the combiner node may be included to support performance monitoring of OTA combiner. The second (e.g., global) AI/ML model transmitted from the combiner node to the WTRU may be included to support performance monitoring of OTA combiner. An OTA performance monitoring configuration message transmitted from the combiner node to the WTRU may be included to support performance monitoring of OTA combiner. For example, the OTA performance monitoring configuration message may include one or more of the following: a performance threshold (e.g., 50% accuracy in classification use case); a performance update threshold (e.g., the performance difference between the first and second AI/ML models); and/or a model update threshold (e.g., the delta between first (e.g., locally trained) and second (e.g., global) AI/ML model parameter(s)). OTA performance monitoring feedback transmitted from the WTRU to the combiner node may be included to support performance monitoring of OTA combiner.

Procedures for performance monitoring of OTA combiner may be described herein (e.g., as shown in FIG. 17). The network can refer to one or more (e.g., any) node in the network (e.g., combiner node, gNB, another WTRU (e.g., sidelink, WTRU-to-WTRU direct communication), etc.).

The WTRU (and/or a WTRU group) may be configured to participate in one or more OTA-FL training rounds. The WTRU may receive an indication to identify which part(s) of the AI/ML model may be trained and/or updated through OTA-FL training rounds (e.g., only last few layers may be trained). The WTRU may receive uplink resource allocations for OTA-FL training rounds, which may be common for one or more (e.g., all) WTRUs participating in the same one or more OTA-FL training round(s). This may mean that one or more (e.g., all) WTRUs use the same uplink resources to transmit the first (e.g., locally trained) AI/ML model parameter(s). The WTRU may receive the uplink OTA-RS allocations as a part of the uplink resource allocation for OTA-FL training rounds. The WTRU may receive a configuration about how the first (e.g., locally trained) AI/ML model parameter(s) are mapped to uplink resources (e.g., as shown in FIG. 7). The WTRU may be configured with uplink pre-equalization technique (e.g., no pre-equalization, phase correction, channel inversion, AI/ML-based OTA pre-equalizer). The WTRU may receive training related information (e.g., loss function, learning rate, a set of threshold(s) to monitor the training progress, etc.). The WTRU may be configured to transmit another (e.g., new) uplink reference signal (e.g., uplink OTA-RS). The WTRU may receive the uplink OTA-RS allocation(s) as a part of the uplink resource allocation. For example, a first device (e.g., WTRU) may receive configuration information. The configuration information may include an indication to participate in one or more OTA-FL training rounds. The configuration information may indicate one or more portions of an AI/ML model that may be trained and/or updated through the one or more OTA-FL training rounds.

The WTRU may transmit (e.g., uplink) OTA-RS to the network. For example, a first device (e.g., WTRU) may send (e.g., uplink) OTA-RS(s) to a second device.

The WTRU (and/or a WTRU group) may transmit parameter(s) of a first (e.g., locally trained) AI/ML model, for example, through the uplink resources allocated for OTA-FL transmission (e.g., OTA aggregation), based on the OTA-FL training round configuration. For example, a first device (e.g., WTRU) may send one or more parameters of a first (e.g., locally trained) AI/ML model to a second device (e.g., WTRU, network node, etc.). The one or more parameters may be sent based on the configuration information (e.g., OTA-FL training round configuration).

The WTRU (and/or a WTRU group) may receive parameter(s) of a second (e.g., global) AI/ML model (and/or a part of a second AI/ML model) from the network. The first (e.g., locally trained) and/or second (e.g., global) AI/ML models may have a common neural network architecture to perform the same and/or similar function(s). For example, the first device (e.g., WTRU) may receive an indication of one or more parameters. The indication may indicate one or more parameters of a second (e.g., global) AI/ML model (and/or a portion of the second AI/ML) model. The first device (e.g., WTRU) may receive the indication from a second device (e.g., network).

The first device (e.g., WTRU) may receive configuration information that indicates OTA performance monitoring configuration information. The first device (e.g., WTRU) may receive the OTA performance monitoring configuration information from a second device (e.g., network). For example, the first device (e.g., WTRU) may receive an OTA performance monitoring configuration message from the network. The first device (e.g., WTRU) may use an OTA performance monitoring configuration message to test and/or monitor the performance of the received second (e.g., global) AI/ML model. The OTA performance monitoring configuration message may include one or more of the following: a performance threshold (e.g., 50% accuracy in classification use case); a performance update threshold (e.g., the performance difference between the first and second AI/ML models); and/or a model update threshold (e.g., the delta between first (e.g., locally trained) and second (e.g., global) AI/ML model parameter(s).

The first device (e.g., WTRU) may send feedback. For example, the first device (e.g., WTRU) may send OTA performance monitoring feedback. Tje WTRU may transmit OTA performance monitoring feedback (e.g., determined using the OTA performance monitoring configuration). The OTA performance monitoring feedback may trigger (the WTRU and/or the network) to initiate online learning of AI/ML-based OTA combiner. The OTA performance monitoring feedback may trigger (the WTRU and/or the network) to initiate the online learning of AI/ML-based OTA pre-equalizer.

One or more of the following exemplary events may trigger the WTRU to send the OTA performance monitoring feedback. In examples, the performance monitoring threshold may be set to 50% accuracy in a classification use case. If the received second (e.g., global) AI/ML model achieves (e.g., only) 20% accuracy, for example, the WTRU may transmit OTA performance monitoring feedback. In examples, the performance update threshold may be set to −10% accuracy in a classification use case. If the received second (e.g., global) AI/ML model achieves (e.g., only) 40% accuracy, while the first (e.g., locally trained) AI/ML model achieves 60% accuracy, for example, the delta may be −20% accuracy. Since the delta is lower than the configured performance update threshold, for example, the WTRU may transmit OTA performance monitoring feedback. In examples, the model update threshold may be set to δ. w_{1,i} may refer to the model parameter(s) of the first (e.g., locally trained) AI/ML model. w_{2,i} may refer to the model parameter(s) of the second (e.g., global) AI/ML model. i∈{1, 2, . . . , P} may represent the index of model parameter(s). When

$$δ > {max}_{i} \vert {w}_{1 , i} - {w}_{2 , i} \vert and / or δ > {\sum }_{i = 1}^{P} \vert {w}_{1 , i} - {w}_{2 , i} \vert and / or δ > \frac{1}{P} {\sum }_{i = 1}^{P} \vert {w}_{1 , i} - {w}_{2 , i} \vert ,$$

for example, the WTRU may transmit OTA performance monitoring feedback.

FIG. 17 depicts an example flowchart of WTRU procedures for performance monitoring of OTA combiner 1700. At 1702, the WTRU (and/or a WTRU group) may be configured to participate in one or more OTA-FL training rounds. At 1704, the WTRU may transmit uplink OTA-RS(s) to the network. At 1706, the WTRU may transmit one or more parameters of a first (e.g., locally trained) AI/ML model, for example, through uplink resources allocated for OTA-FL transmission, based on the OTA-FL training round configuration. At 1708, the WTRU may receive one or more parameters of a second (e.g., global) AI/ML model from the network. At 1710, the WTRU may receive an OTA performance monitoring configuration message from the network. At 1712, the WTRU may transmit OTA performance monitoring feedback to the network. The OTA performance monitoring feedback may trigger the WTRU and/or the network to initiate the online learning of AI/ML-based OTA combiner. At 1712, additionally or alternatively, the OTA performance monitoring feedback may trigger the WTRU and/or the network to initiate the online learning of AI/ML-based OTA pre-equalizer.

1. A first device comprising:
a processor configured to:
receive first configuration information, wherein the first configuration information indicates that the first device is to participate in online learning of an over-the-air (OTA) combiner at a second device;
receive second configuration information, wherein the second configuration information is associated with training data that is associated with the online learning of the OTA combiner;
send the training data based on the second configuration information;
receive third configuration information; and
send a transmission based on the third configuration information.

2. The first device of claim 1, wherein the first configuration information indicates whether the online learning of the OTA combiner is performed periodically, aperiodically, or semi-persistently.

3. The first device of claim 1, wherein the second configuration information indicates an allocation of time domain resources, frequency domain resources, or code domain resources; and
wherein the processor is configured to send the training data via the one or more OTA-RSs using the time domain resources, frequency domain resources, or code domain resources, wherein the training data is configured to train the OTA combiner based on the one or more OTA-RSs or one or more artificial intelligence machine learning (AIML) models used for an OTA pre-equalizer.

4. The first device of claim 1, wherein the one or more OTA-RSs are characterized by a higher density than a physical uplink shared channel (PUSCH) demodulation reference signal (DMRS) or a sounding reference signal (SRS).

5. The first device of claim 3, wherein the second configuration information indicates that the allocation of time domain resources, frequency domain resources, or code domain resources partially overlap or fully overlap with the allocation of time domain resources, frequency domain resources, or code domain resources allocated for OTA-RS transmissions performed by a third device that is a part of the online learning of the OTA combiner.

6. The first device of claim 1, wherein the second configuration information indicates an allocation of time domain resources, frequency domain resources, or code domain resources for the one or more OTA-RSs, and wherein the allocation of time domain resources, frequency domain resources, or code domain resources result in at least a portion of the OTA-RS transmissions being multiplexed with uplink data.

7. The first device of claim 1, wherein the third configuration information comprises one or more of an indication of an uplink scaling factor, an indication of an uplink pre-equalization technique, an indication of an OTA combining technique at the second device, or information associated with whether a plurality of first devices comprise the first device and whether the plurality of first devices is participating in the online learning of the OTA combiner; and
wherein the transmission is sent based on one or more of the indication of the uplink scaling factor, the indication of the uplink pre-equalization technique, the indication of the OTA combining technique at the second device, or the information associated with whether the plurality of first devices comprise the first device and whether the plurality of first devices is participating in the online learning of the OTA combiner.

8. The first device of claim 1, wherein the processor is configured to:
receive fourth configuration information, wherein the fourth configuration information comprises information to train an OTA pre-equalizer; and
receive an indication of one or more gradients of end-to-end loss associated with the first device and the second device, wherein the OTA pre-equalizer is trained based on the one or more gradients of end-to-end loss and a differentiation chain rule.

9. The first device of claim 1, wherein the processor is configured to:
receive fourth configuration information, wherein the fourth configuration information comprises information to train an OTA pre-equalizer; and
receive one or more OTA aggregation metrics, wherein the OTA pre-equalizer is trained based on the one or more OTA aggregation metrics.

10. The first device of claim 1, wherein the first device is a wireless transmit/receive unit (WTRU) or a base station.

11. The first device of claim 1, wherein the processor is configured to:
receive fourth configuration information, wherein the fourth configuration information comprises information that indicates an OTA pre-equalizer out of a plurality of OTA pre-equalizers; and
pre-equalize model parameters included in the transmission prior to sending the transmission using the OTA pre-equalizer indicated by the fourth configuration information.

12. The first device of claim 1, further comprising an artificial intelligence machine learning (AIML) model, wherein the transmission comprises one or more model parameters associated with the AIML model, wherein the AIML model is configured for one or more inference use cases, and wherein the training data is configured to train the OTA combiner such that the OTA combiner is configured to reduce OTA aggregation error associated with each transmission sent from the first device or each transmission sent from a third device.

13. The first device of claim 1, wherein a plurality of devices comprises the first device, and wherein the OTA combiner is configured to combine each respective transmission from each device of the plurality of devices.

14. A method performed by a first device, the method comprising:
receiving first configuration information, wherein the first configuration information indicates that the first device is to participate in online learning of an over-the-air (OTA) combiner at a second device;
receiving second configuration information, wherein the second configuration information is associated with training data that is associated with the online learning of the OTA combiner;
sending the training data via one or more OTA-reference signals (RSs) based on the second configuration information;
receiving third configuration information; and
sending a transmission based on the third configuration information.

15. The method of claim 14, wherein the first configuration information indicates whether the online learning of the OTA combiner is performed periodically, aperiodically, or semi-persistently.

16. The method of claim 14, wherein the second configuration information indicates an allocation of time domain resources, frequency domain resources, or code domain resources; and
wherein the processor is configured to send the training data via the one or more OTA-RSs using the time domain resources, frequency domain resources, or code domain resources, wherein the training data is configured to train the OTA combiner based on the one or more OTA-RSs or one or more artificial intelligence machine learning (AIML) models used for an OTA pre-equalizer.

17. The method of claim 14, wherein the one or more OTA-RSs are characterized by a higher density than a physical uplink shared channel (PUSCH) demodulation reference signal (DMRS) or a sounding reference signal (SRS).

18. The method of claim 16, wherein the second configuration information indicates that the allocation of time domain resources, frequency domain resources, or code domain resources partially overlap or fully overlap with the allocation of time domain resources, frequency domain resources, or code domain resources allocated for OTA-RS transmissions performed by a third device that is a part of the online learning of the OTA combiner.

19. The method of claim 18, wherein the second configuration information indicates an allocation of time domain resources, frequency domain resources, or code domain resources for the one or more OTA-RSs, and wherein the allocation of time domain resources, frequency domain resources, or code domain resources result in at least a portion of the OTA-RS transmissions being multiplexed with uplink data.

20. The method of claim 14, wherein the third configuration information comprises one or more of an indication of an uplink scaling factor, an indication of an uplink pre-equalization technique, an indication of an OTA combining technique at the second device, or information associated with whether a plurality of first devices comprise the first device and whether the plurality of first devices is participating in the online learning of the OTA combiner; and
wherein the transmission is sent based on one or more of the indication of the uplink scaling factor, the indication of the uplink pre-equalization technique, the indication of the OTA combining technique at the second device, or the information associated with whether the plurality of first devices comprise the first device and whether the plurality of first devices is participating in the online learning of the OTA combiner.
